(19) United States
(12) Patent Application Publication
(10) Pub. No.: US 2023/0012460 A1
(43) Pub. Date: Jan. 12, 2023

(54) Fraud Detection and Prevention System

(71) Applicant: Brightwell Payments Inc., Atlanta, GA (US)

(72) Inventors: Larry E. Hipp, Johns Creek, GA (US); Daniel Chimento, Atlanta, GA (US); Kyle C. Fix, Atlanta, GA (US); Nic Rosental, Atlanta, GA (US)

(21) Appl. No.: 17/859,889

(22) Filed: Jul. 7, 2022

Related U.S. Application Data
(60) Provisional application No. 63/219,183, filed on Jul. 7, 2021.

(51) Int. Cl. G06Q 20/40

(52) U.S. Cl. CPC G06Q 20/4016; G06Q 20/405

(57) ABSTRACT

Systems, apparatuses, and methods are described for detecting and preventing suspicious payment card authorization attempts at a merchant level. A computing device may receive a plurality of authorization attempts and store the plurality of authorization attempts in a database. Each authorization attempt may correspond to an attempted transaction and may be associated with a respective merchant. The computing device may generate a database query configured to retrieve a first plurality of authorization attempts corresponding to a first merchant. The database query may be generated based on first criteria corresponding to a first notification rule, and the first criteria may be configured to detect a pattern of authorization attempts at a given merchant and associated with a potential account testing attack. The computing device may determine a suspicious status for the merchant and perform one or more actions associated with the merchant.

### CROSS-REFERENCE TO RELATED APPLICATION

The present application is a US non-provisional application claiming priority to U.S. Provisional Application No. 63/219,183, entitled “Fraud Detection and Prevention System,” filed Jul. 7, 2021. The prior application is incorporated herein in its entirety.

### FIELD

Aspects of the disclosure relate to detecting and preventing suspicious payment card authorization attempts. In particular, one or more aspects of the disclosure relate to detecting enumeration attacks and other attacks based on transactions of multiple users and merchants.

### BACKGROUND

Fraudulent actors continue to discover new ways of committing electronic payment card fraud (e.g., credit, debit, and/or prepaid card fraud). As technology increases and the ability to detect fraud improves, fraudulent actors continue to develop their techniques or approaches to overcome or bypass security filters. For example, fraudulent actors may use enumeration attacks (e.g., card testing, account testing) to determine the validity of credit card numbers, or other types of card numbers. Enumeration attacks may involve hundreds of millions of authorization attempts against tens of thousands of accounts. Even if fraudulent actors are only successful in accessing some of the accounts, these fraud attacks can result in millions of dollars stolen.

An enumeration attack may be a type of “brute force” attack. Fraudulent actors may enumerate over all the possibilities of card information by, for example, trying every possible number. For example, fraudulent actors may first obtain card information (e.g., at least part of the bank identification numbers (BIN), full card numbers, expiration dates, card security codes corresponding to valid cards) by purchasing or stealing card information, and/or via phishing or spyware software. Then, with the card information in hand, fraudulent actors may attempt small purchases on a merchant's website to check if the purchases are approved. If not, fraudulent actors may continue to try and validate other card information (e.g., the unknown portions of the full card numbers, expiration dates, card security codes). Fraudulent users may try different combinations of card numbers, expiration dates, and card security codes (e.g., correct card numbers but incorrect expiration dates, correct card numbers but incorrect card security codes). Based on the results of the transactions, fraudulent users may obtain information indicating the correct combinations of card numbers, expiration dates, and/or card security codes. Fraudulent users may also rule out incorrect card numbers, expiration dates, and/or card security codes.

In addition, fraudulent actors may program networks of compromised computers (e.g., botnets) to run thousands of low-value transactions at a time, instead of running manual testing, which is time-consuming and labor-intensive. To make things worse, fraudulent actors may take advantage of artificial intelligence and big data to exploit the vulnerabilities of merchants and transaction authorization networks and quickly obtain valid card information. Once the fraudulent actors obtain valid card information, the card information may be sold on the dark web or used in other ways, resulting in significant losses for merchants, cardholders, and payment card issuers.

One reason enumeration attacks can be successful is that many transaction monitoring systems and tools fail to detect or block such fraudulent transactions. These transaction monitoring systems and tools only evaluate transaction data at a card level (e.g., individual user level). As a result, each card transaction is analyzed individually, which may cause approval of malicious payment attempts as long as the card information is correct, and failure to identify a trend and/or pattern associated with the hundreds of millions of authorization attempts. Additionally, fraudulent actors may funnel card testing attempts through multiple (e.g., hundreds) of merchants such that any individual merchant is not alerted to a high volume of invalid transaction attempts. Such individual analysis may also consume significant computational resources and cause delays in identifying and blocking unauthorized or malicious authorization attempts. There is a long-felt need for more efficiently and accurately identifying and preventing unauthorized or malicious authorization attempts. These and other shortcomings are addressed in the disclosure.

### SUMMARY

The following summary presents a simplified summary of certain features. The summary is not an extensive overview and is not intended to identify key or critical elements.

Aspects described herein may provide fraud detection and prevention computing platform suitable for detecting enumeration attacks and other attacks across multiple merchants and users. In particular, some aspects provide a fraud detection and prevention computing platform that analyzes card transactions at a merchant level. For example, a fraud detection and prevention computing platform may receive a plurality of authorization attempts (e.g., initiated transactions, approved authorization attempts, denied authorization attempts) from transaction authorization networks. The fraud detection and prevention computing platform may analyze the received authorization attempts based on one or more criteria of notification rules. The analysis may identify a trend and/or pattern associated with the received authorization attempts that suggests one or more merchants are being used by fraudulent actors to carry out an enumeration attack. The fraud detection and prevention computing platform may generate one or more notifications based on the analysis. These notifications may indicate a suspicious status for the merchants. These notifications may trigger an event listener to perform one or more actions based on the analysis, such as adding the merchants to a block list so that future authorization attempts on the merchants may be denied until the enumeration attack is resolved. Further, techniques that take advantage of the database architecture and algorithms in the disclosure may identify a trend associated with the merchants and identify suspicious authorization attempts at a merchant level, even if the authorization attempts have been approved (or not flagged) by other entities (e.g., transaction authorization networks). And even if the other entities identified the authorization attempts as including partially invalid information, aspects described herein may identify a trend at the merchant level and thus distinguish between simple user error and a coordinated attack.

Systems, apparatuses, and methods are described for detecting and preventing suspicious payment card authorization attempts at a merchant level. In an illustrative embodiment, a method may be provided for detecting and preventing suspicious payment card authorization attempts at a merchant level. In the method, a computing device may receive a plurality of authorization attempts from one or more transaction authorization networks. The computing device may store the plurality of authorization attempts in a database. Each authorization attempt may correspond to an attempted transaction and may be associated with a respective merchant of a plurality of merchants and a respective user account of a plurality of user accounts. The computing device may generate a database query configured to retrieve a first plurality of authorization attempts corresponding to a first merchant and a first plurality of user accounts. The database query may be generated based on first criteria corresponding to a first notification rule of a plurality of notification rules. The first criteria of the first notification rule may be configured to detect a pattern of authorization attempts at a given merchant and associated with a potential account testing attack. The computing device may generate a notification indicating a suspicious status for the first merchant based on determining that the first plurality of authorization attempts satisfies the first criteria The computing device may determine, based on the suspicious status for the first merchant, that the first plurality of user accounts is likely compromised. The computing device may perform, based on the suspicious status for the first merchant, a first action associated with the first merchant. The computing device may determine, based on the suspicious status for the first merchant, at least one other user account that is also likely compromised. The computing device may perform, based on determining the at least one other user account, a second action associated with the at least one other user account.

In an embodiment, the computing device may determine the at least one other user account by determining, based on the at least one other user account and one of the first plurality of user accounts sharing same partial card information, the at least one other user account.

In an embodiment, the computing device may determine the at least one other user account by determining, based on the at least one other user account being used at the first merchant during a first time period different from a second time period in which the first plurality of authorization attempts is received, the at least one other user account.

In an embodiment, the first action may comprise denying the first plurality of authorization attempts and future authorization attempts associated with the first merchant.

In an embodiment, the first action may comprise adding the first merchant to a block list that comprises a list of merchants with a suspicious status.

In an embodiment, the first action may comprise denying a first authorization attempt associated with the first merchant based on the determined suspicious status for the first merchant. The first authorization attempt may be one of the received plurality of authorization attempts or a future authorization attempt.

In an embodiment, the first action may comprise generating an alert indicating the determined suspicious status of the first merchant.

In an embodiment, the second action may comprise denying future authorization attempts associated with the at least one other user account.

In an embodiment, the computing device may determine, based on a second plurality of authorization attempts corresponding to a second merchant and corresponding to the at least one other user account, a suspicious status for the second merchant. The second action may comprise denying the second plurality of authorization attempts and future authorization attempts associated with the second merchant.

In an embodiment, the first criteria of the first notification rule may comprise a threshold number of authorization attempts on a merchant during a time interval, and the computing device may determine whether a total number of authorization attempts, of the first plurality of authorization attempts, satisfies the threshold number.

In an embodiment, the first criteria of the first notification rule may comprise a threshold number of authorization declines from a merchant during a time interval, and the computing device may determine whether a total number of authorization attempts that are declined, of the first plurality of authorization attempts, satisfies the threshold number.

In an embodiment, the first criteria of the first notification rule may comprise a threshold number of authorization declines, based on a first decline reason, from a merchant during a time interval, and the computing device may determine whether a total number of authorization attempts that are declined based on the first decline reason, of the first plurality of authorization attempts, satisfies the threshold number.

In an embodiment, the first criteria of the first notification rule may comprise a threshold number of authorization attempts for a same amount on a merchant, and the computing device may determine whether a total number of authorization attempts for a given value, of the first plurality of authorization attempts, satisfies the threshold number.

In an embodiment, the first criteria of the first notification rule may comprise a threshold number of authorization attempts for a zero amount on a merchant, and the computing device may determine whether a total number of authorization attempts for a zero value, of the first plurality of authorization attempts, satisfies the threshold number.

In an embodiment, the first criteria of the first notification rule may comprise whether a name of a merchant comprises a web address and a threshold percentage of authorization declines from a merchant during a time interval. The computing device may determine whether a name of the first merchant comprises a web address and whether a percentage of authorization attempts that are declined, of the first plurality of authorization attempts, satisfies the threshold percentage.

In an embodiment, the first criteria of the first notification rule may comprise whether a merchant is associated with prior authorization attempts stored in the database and a threshold number of authorization attempts on a merchant during a time interval. The computing device may determine whether the first merchant is associated with prior authorization attempts stored in the database and whether a total number of authorization attempts, of the first plurality of authorization attempts, satisfies the threshold number.

In an embodiment, the computing device may determine, based on determining that the first plurality of authorization attempts satisfies the first criteria of the first notification rule and based on determining that the first plurality of authorization attempts satisfies second criteria of a second notification rule, the suspicious status for the first merchant.

In an embodiment, the first notification rule may be associated with a first weighting value and each rule of the at least one different second notification rule may be associated with a respective second weighting value. The computing device may determine an aggregate score for the first merchant by applying the first weighting value to the notification and the respective second weighting value to the at least one second notification.

In an embodiment, the notification may be generated further based on output of a machine learning model trained to correlate the plurality of notification rules with a suspicious status of a merchant.

In an embodiment, the notification may be generated further based on characteristics of the first plurality of authorization attempts, and the characteristics may comprise at least one of the following: a total number of the first plurality of authorization attempts, one or more decline reasons for at least one of the first plurality of authorization attempts, a total number of the first plurality of authorization attempts for a same amount, a total number of the first plurality of authorization attempts for zero amount, an indication whether a name of the first merchant comprises a web address, or an indication whether the first merchant is associated with prior authorization attempts stored in the database.

In an embodiment, the authorization attempts may comprise a first set of plurality of authorization attempts denied by an operator of the transaction authorization network and a second set of plurality of authorization attempts approved by the operator of the transaction authorization network.

In an embodiment, the plurality of authorization attempts might not have been flagged by an operator of the transaction authorization network as having a suspicious status.

In an embodiment, the computing device may receive the plurality authorization attempts from more than one transaction authorization networks. The more than one transaction authorization networks may have different operators.

In an embodiment, the first action may comprise denying, based on the suspicious status for the first merchant and characteristics of one of the first plurality of authorization attempts, the one of the first plurality of authorization attempts. The characteristics of one of the first plurality of authorization attempts may comprise at least one of the following: a user account associated with the one of the first plurality of authorization attempts, a card security code associated with the one of the first plurality of authorization attempts, an expiration date of a payment card associated with the one of the first plurality of authorization attempts, or a number of times that a user account associated with the one of the first plurality of authorization attempts has been used to attempt to purchase an item from the merchant.

In an embodiment, the computing device may determine that the first merchant is in a safe list. The safe list may comprise a list of merchants that are trusted by the computing device. The first notification rule may comprise a threshold number of authorization attempts on a merchant during a time interval, and a threshold number of authorization attempts on the first merchant may be different from a threshold number of authorization attempts on a second merchant that is not in the safe list.

In an embodiment, a method may be provided for detecting and preventing suspicious payment card authorization attempts for multiple merchants. In the method, a computing device may receive a plurality of authorization attempts from one or more transaction authorization networks. The computing device may store the plurality of authorization attempts in a database. Each authorization attempt may correspond to an attempted transaction and may be associated with a respective merchant of a plurality of merchants and a respective user account of a plurality of user accounts. The computing device may generate one or more database queries configured to retrieve a first plurality of authorization attempts corresponding to a first merchant and a first plurality of user accounts and a second plurality of authorization attempts corresponding to a second merchant and a second plurality of user accounts. The one or more database queries may be generated based on first criteria corresponding to a first notification rule. The first criteria of the first notification rule may be configured to detect a respective pattern of authorization attempts at multiple merchants and associated with a potential account testing. The computing device may generate a notification indicating a suspicious status for the first merchant and the second merchant based on determining that the first plurality of authorization attempts and the second plurality of authorization attempts satisfy the first criteria of the first notification rule. The computing device may determine, based on the suspicious status for the first merchant and the second merchant, that the first plurality of user accounts and second plurality of user accounts are likely compromised, and perform, based on the suspicious status for the first merchant and the second merchant, an action associated with the first merchant and the second merchant.

In an embodiment, the action may comprise denying the first plurality of authorization attempts and future authorization attempts associated with the first merchant and denying the second plurality of authorization attempts and future authorization attempts associated with the second merchant.

In an embodiment, the action may comprise adding the first merchant and the second merchant to a block list that comprises a list of merchants with a suspicious status.

In an embodiment, the first plurality of user accounts and the second plurality of user accounts may share at least one same user account.

In an embodiment, the computing device may determine, based on the suspicious status for the first merchant and the second merchant, at least one other user account as being likely compromised, and perform, based on determining the at least one other user account as being likely compromised, a second action associated with the at least one other user account.

In an embodiment, the first criteria of the first notification rule may comprise a threshold number of authorization attempts on a merchant during a time interval. The computing device may determine whether a total number of authorization attempts, of the first plurality of authorization attempts, satisfies the threshold number and whether a total number of authorization attempts, of the second plurality of authorization attempts, satisfies the threshold number.

In an embodiment, one or more apparatuses may be provided to perform one or more of the processes described herein. In an embodiment of the present disclosure, one or more non-transitory computer readable media may be provided to perform one or more of the processes described herein.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative computing environment for detecting and preventing suspicious payment card authorization attempts in accordance with one or more example embodiments.

FIG. 2 depicts example hardware elements of a computing device in accordance with one or more example embodiments.

FIG. 3 depicts example components of a computing platform in accordance with one or more example embodiments.

FIG. 4 depicts an illustrative event sequence for detecting and preventing suspicious payment card authorization attempts in accordance with one or more example embodiments.

FIGS. 5A-5C depict an illustrative method for detecting and preventing suspicious payment card authorization attempts associated with one merchant in accordance with one or more example embodiments.

FIG. 6 depicts an example user interface associated with detecting and preventing suspicious payment card authorization attempts in accordance with one or more example embodiments.

FIG. 7 depicts an illustrative method for detecting and preventing suspicious payment card authorization attempts associated with multiple merchants in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As illustrated in greater detail below, aspects of the disclosure may provide a fraud detection and prevention computing platform that can detect enumeration attacks and other attacks across multiple merchants and users, and take steps to block such attacks in real time (or near real time). In particular, one or more aspects of the disclosure provide a fraud detection and prevention computing platform that analyzes card transactions at a merchant level. The fraud detection and prevention computing platform may receive a plurality of authorization attempts, comprising attempted transactions (whether successful or not) from transaction authorization networks (e.g., VISA, FIS). The fraud detection and prevention computing platform may analyze the received authorization attempts based on one or more notification rules configured to identify a trend and/or pattern associated with the received authorization attempts that suggests one or more merchants are being used by fraudulent actors to carry out an enumeration attack. As one example, the notification rules may include criteria related to a number of invalid authorization attempts on a given merchant during a defined time window. The fraud detection and prevention computing platform may generate one or more notifications based on the analysis, indicating the notification rule underlying the notification and the relevant details of the merchant and the activity that satisfied the rule. One or more event listeners may receive and act on the notification, determining whether the notification and the relevant details establish a sufficient likelihood of an enumeration attack on the merchant. If the merchant has a suspicious status, the event listener may take suitable action(s). For example, the event listener (or a different device) may add the merchant to a block list and prevent further transaction attempts from that merchant from being accepted. Also or alternatively, the event listener may flag the merchant as suspicious, and flag cards associated with the authorization attempts on the merchant based on the suspicious status of the merchant. The event listener may also add the cards to a block list and prevent further transaction attempts from that card being accepted. Also or alternatively, the event listener may flag the cards as being likely compromised. In some examples, cards that are not associated with the authorization attempts on the merchant, but are used at the same merchant during a defined time period (e.g., 1 day before and/or after the authorization attempts are received), may also be flagged as being likely compromised and/or blocked for at least a period of time. In addition, cards that are not associated with the authorization attempts on the merchant, but share the same partial information (e.g., BIN, issuer identification number (IIN)) with the cards associated with the authorization attempts, may also be flagged as being likely compromised and/or blocked for at least a period of time. After cards and merchants are flagged as suspicious and/or blocked, the fraud detection and prevention computing platform confirm or deny that an enumeration attack actually occurred (e.g., based on human review or other methods) and may perform additional actions on the cards and merchants (e.g., issue new cards).

Some aspects of the disclosure may provide technical benefits that are not provided by conventional systems. For example, one or more aspects of the disclosure may improve the existing transaction monitoring systems and tools by providing a fraud detection and prevention computing platform that analyzes card transactions at a merchant level. Merchants may analyze and validate transactions only at a card or individual level and fail to analyze card transactions at a merchant level because the merchants lack the technical abilities. For example, a merchant may have access only to the data associated with the merchant and might not be able to identify a card transaction trend and/or pattern. If fraudulent users target 100 merchants with only 10 authorization attempts for each merchant, an individual merchant might not be able to detect any abnormal card transaction trend and/or pattern. But a card issuer may have access to authorization attempts across all the corresponding users and may detect any abnormal activities (e.g., enumeration attack) based on the authorization attempts. In addition, transaction authorization networks may analyze and validate transactions only at a card or individual level and fail to analyze card transactions at a merchant level because their financial incentives are not aligned with the business goals. Even if a transaction authorization network may have access to authorization attempts across all the corresponding users, a transaction authorization network may collect an interchange fee for every transaction, so a transaction authorization network's incentive to identify fraudulent transactions may not be the same as a card issuer. Service agreements may limit the liability of the transaction authorization network or merchant when a fraudulent actor presents correct account information, further reducing the incentive of the transaction authorization network to prevent attacks of this type.

In addition, some aspects of the disclosure may identify suspicious authorization attempts at a merchant level, when some of the authorization attempts that were sent through by other entities are invalid. For example, a transaction authorization network may send through authorization attempts to a card issuer even if the authorization attempts are deemed invalid due to partially incorrect information such as incorrect expiration dates or card security codes. Based on the partially incorrect information, a fraud detection and prevention computing platform may identify a trend associated with one or more merchants and identify suspicious authorization attempts at a merchant level. Further, some aspects of the disclosure may identify suspicious authorization attempts at a merchant level, even if the authorization attempts have been approved (or not flagged) by other entities. For example, some aspects of the disclosure may efficiently and accurately identify potentially compromised merchants (e.g., merchants that are being used by fraudulent actors to carry out enumeration attacks or other attacks) based on simple indicators such as a number of authorization attempts associated with a merchant during a specific time interval, and provide actionable insights (e.g., merchant information, card profiles, transaction information) to administrators, and/or other computing devices or business entities.

Further, some aspects of the disclosure may identify other likely compromised merchants, cards, and/or user accounts based on the received authorization attempts at a first merchant. For example, the computing device may aggregate the received authorization attempts for multiple merchants and apply an aggregate rule that identifies all the merchants that are likely subject to an enumeration attack. The computing device may also identify other cards and user accounts if those cards have been used at the compromised merchant during a time period and/or share the same partial information with the cards associated with the authorization attempts. In this way, additional vulnerable merchants, cards, and user accounts may be determined to avoid further monetary loss.

Further, some aspects of the disclosure may quickly and efficiently distinguish suspicious and potentially fraudulent authorization attempts from “innocent” invalid authorization attempts (e.g., accidental entering of wrong information or other mistakes). A technical challenge to overcome is being able to quickly separate these “innocent” invalid authorization attempts from suspicious and potentially fraudulent authorization attempts. Some aspects of the disclosure may overcome the challenge by quickly and accurately identifying fraudulent authorization attempts at a merchant level with minimal false positives (e.g., mistakenly identifying “innocent” invalid authorization attempts), as fraud detection techniques that yield too many false positives may potentially cause user frustration.

Further, one or more aspects of the disclosure may provide automated approval or denial of authorization attempts at a merchant level, which improves technical operations and efficiency of the high-volume payment processing, and significantly reduces the number of fraudulent authorizations. Some aspects of the disclosure may analyze the transaction data in real time (or near real time) and may make very quick identifications and take actions to prevent expansive fraud from further occurring. According to some aspects, automated fraud monitoring software can identify enumeration attacks early and as they begin to grow. Early detection can be important with a brute force attack, as the longer the attack is allowed to run the more likely it will stumble upon correct information. However, if a human undertook the analysis alone, to the extent possible, it may be far too late to identify the source of fraud and prevent fraudulent transactions. Human analysis, at best, might be able to only identify the bulk of the issues after the fact and then cause the merchant to have to take significant remedial efforts. In fact, techniques that take advantage of the database architecture and algorithms in the disclosure, can identify and block hundreds of compromised merchants, hundreds-of-thousands of fraudulent authorizations and transactions, with summed values in the millions of dollars within seconds, far beyond the accuracy and magnitude possible by manual analysis. These fraudulent authorizations were not flagged or otherwise identified by any other entities or humans as suspicious. Various other technical benefits may be achieved as well.

Although the methods provided herein and illustrated in the figures are discussed in the context of a card issuer seeking to prevent payment card fraud (e.g., credit, debit, and/or prepaid card fraud), they apply equally to transaction authorization networks as well as third parties (e.g., program manager) that monitor for fraud attacks. The novel methods described herein, relating to applying notification rules and criteria at a merchant level to detect trends that suggest enumeration attacks, can each be performed by any of the card issuer, the transaction authorization networks, or third parties that monitor payment card fraud. The disclosed methods of detecting enumeration attack may be particularly useful when implemented by a transaction authorization network rather than a card issuer. Implementing these methods at a transaction authorization network could even further limit the damage of an enumeration attack by identifying it earlier in a transaction approval process. For the convenience of the reader, the methods and systems are illustrated in the context of a card issuer as actor, but it will be readily appreciated that the disclosed methods may be performed by a transaction authorization network and/or third party rather than the card issuer.

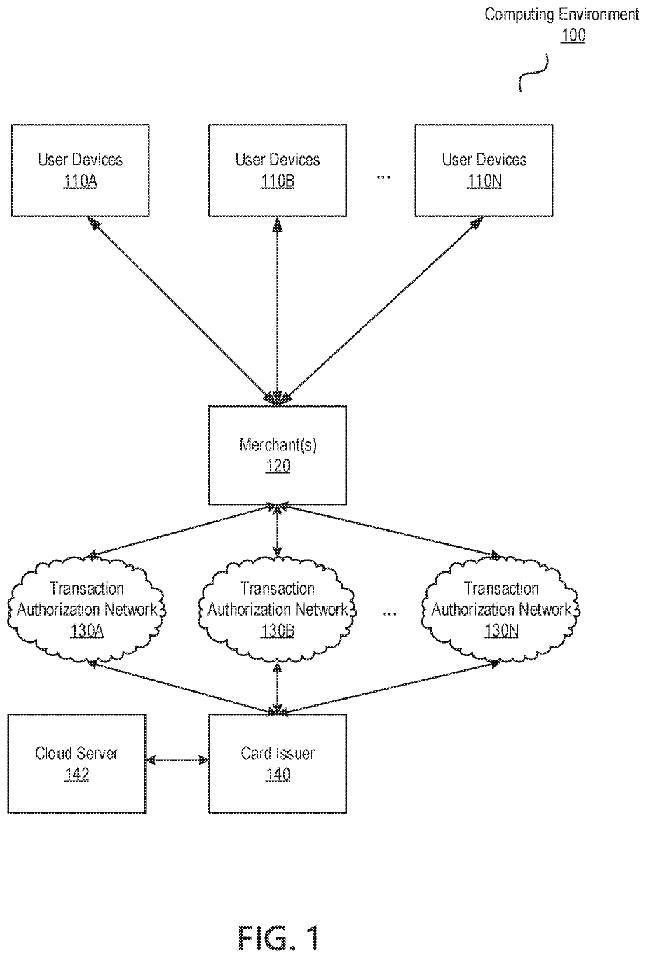

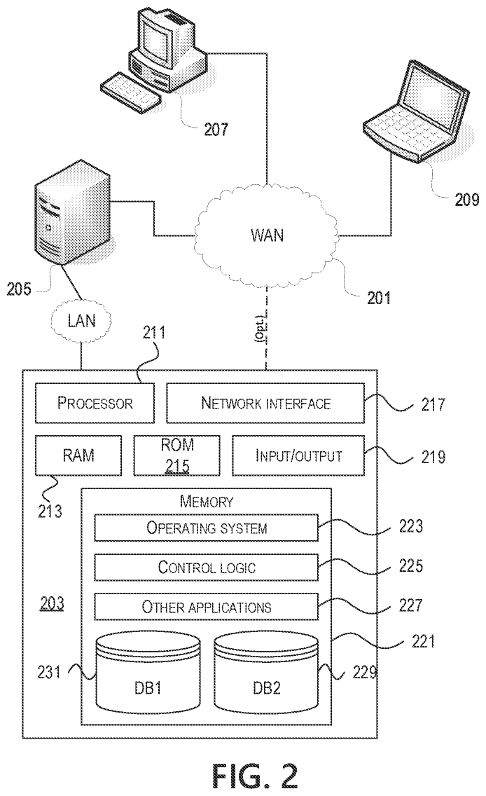

Having discussed some aspects of the disclosure at a high level and example problems and benefits, discussion will now turn to a computing environment and illustrative computing devices that may be used to implement one or more aspects of the disclosure. FIG. 1 depicts an illustrative computing environment for detecting and preventing suspicious payment card authorization attempts in accordance with one or more example embodiments. In FIG. 1, a computing environment 100 may include one or more computing devices, servers, and systems. For example, the computing environment 100 may comprise user devices 110A-110N, one or more merchants 120, transaction authorization networks 130A-130N, a card issuer 140, and a cloud server 142. Each of the user devices 110A-110N, the one or more merchants 120, the transaction authorization networks 130A-130N, the card issuer 140, and the cloud server 142 may be implemented using one or more computing devices, such as the computing device illustrated in FIG. 2.

The user devices 110A-110N of FIG. 1 may comprise one or more computing devices and/or other computer components used to access a merchant web site associated with merchants 120 and initiate transactions, such as attempting to purchase goods from the merchant's online store using payment card information (e.g., credit, debit, and/or prepaid card information). For example, one or more of the user devices 110A-110N may be a mobile computing device (e.g., smartphone, tablet, smart watch, laptop computer, or the like), desktop computing device (e.g., desktop computer, terminal, or the like), or a merchant's point of sale terminal. In addition, the user devices 110A-110N may be linked to and/or used by one or more users (e.g., fraudulent actors). The user devices 110A-110N may be capable of receiving and/or displaying a user interface, receiving or sending input via the user interface, and communicating the received input to one or more other computing devices. The user devices 110A-110N may use the user interface to communicate with the merchants 120, and/or the transaction authorization networks 130A-130N via a network. The user devices 110A-110N may be able to access one or more applications (e.g., online shopping applications, service provider applications) provided by the merchants 120 and/or websites associated with the merchants 120.

User devices 110A-110N may be used by one or more fraudulent actors to submit card testing attempts as part of an enumeration attack on card issuer 140. The fraudulent actors may submit many transaction attempts via the merchants 120 to test different portions of payment card information in an attempt to illicitly access the payment account of another user. One or more of the user devices 110A-110N may comprise a computing system illicitly accessed by fraudulent users to perform card testing or other malicious activities, such as where the fraudulent users have accessed a computing device by way of a virus or backdoor. Also or alternatively, one or more of the user devices 110A-110N may be a number of connected devices (e.g., botnets) that are compromised and/or controlled by users to perform malicious card testing or other malicious activities.

The merchants 120 may be business entities that sell or offer to sell goods and/or services. The merchants 120 may accept card payments (e.g., credit card payments, debit card payments, and/or prepaid card payments) in exchange for goods and/or services. The merchants 120 may operate one or more websites that can be accessed using a browser on user devices (e.g., the user devices 110A-110N). The merchants 120 may comprise one or more computing devices and/or other computer components associated with the sale of goods and/or services. Customers may be required to enter payment card information such as name, card number, expiration date, card security code, and/or billing address for approval of the transaction via, for example, a web browser, a payment terminal, a point of sale system in a physical store, mobile or in-app payment acceptance, touch screens, or other hardware and software options. After a customer enters the payment card information, the merchants 120 may send a request for an authorization attempt (e.g., transaction authorization) to one of the transaction authorization networks 130A-130N. An authorization attempt may comprise information indicating the amount of transaction, information associated with the merchant (e.g., merchant name, merchant ID, merchant category), the goods and/or services associated with the transaction, and/or the payment card information (e.g., a card number, an expiration date, a card security code, a billing address), for example. However, any suitable combination of information required by the transaction authorization networks 130A-130N and the card issuer 140 may be provided in a transaction attempt.

The transaction authorization networks 130A-130N may comprise one or more computing devices and/or other computer components. The transaction authorization networks 130A-130N may provide networks that allow users, customers, merchants (e.g., the merchants 120), and card issuers (e.g., the card issuer 140) to communicate and process transactions. The transaction authorization networks 130A-130N may be third-party systems that manage authorization and/or transaction data for electronic payment cards. For example, the transaction authorization networks 130A-130N may comprise an acquiring bank of the merchants 120 and/or other business entities (e.g., financial institutions) that facilitate the authorization of the transactions. Examples of transaction authorization networks 130A-130N may comprise Visa, FIS Global, Galileo, Mastercard, American Express, Discover, and other payment processors.

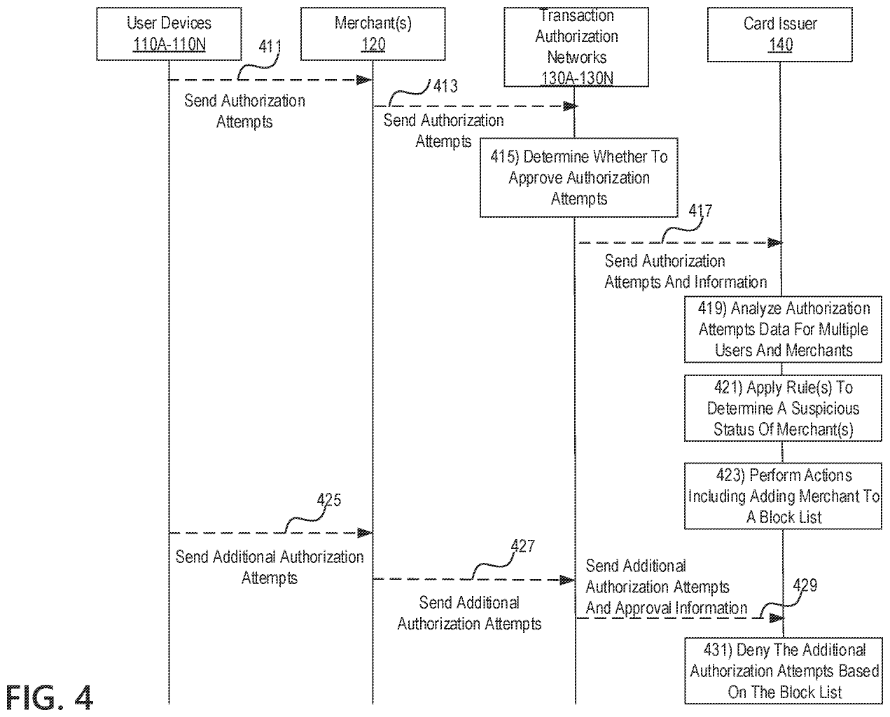

The transaction authorization networks 130A-130N may receive authorization attempts from the merchants 120. For example, as discussed further herein with respect to FIG. 4, the transaction authorization networks 130A-130N may review a received authorization attempt to determine whether it includes a valid card number and corresponding expiration date and card security code. The transaction authorization networks 130A-130N may review the authorization attempts and determine whether to approve one or more of the authorization attempts based on the stored information associated with the payment cards and the merchants 120. An authorization attempt may be determined to be invalid by the transaction authorization networks 130A-130N if, for example, the expiration date and/or the card security code do not correspond to the card number, or the card number itself is incorrect (e.g., the card number is nonexistent or otherwise invalid). The transaction authorization networks 130A-130N may send a record of any authorization attempt on a valid card number to the card issuer 140 associated with the card number. If an authorization attempt on a valid card number is deemed invalid due to an incorrect expiration date or card security code, the transaction authorization networks 130A-130N may indicate that the authorization attempt was not approved yet nonetheless send the authorization attempt to the card issuer 140. If an authorization attempt on a valid card number is deemed valid, the transaction authorization networks 130A-130N may indicate that the authorization attempt was approved and send the authorization attempt to the card issuer 140.

The card issuer 140 may comprise a business entity (e.g., an issuing bank) that issues the payment cards used for the transactions associated with the authorization attempts. Additionally or alternatively, the card issuer 140 may comprise a program manager that manages the payment cards used for the transactions associated with the authorization attempts. The card issuer 140 may verify whether the cardholder has sufficient funds in the account for the transactions. As explained in detail below, the card issuer 140 may comprise a fraud detection and prevention computing platform that identifies and blocks suspicious authorization attempts at a merchant level. The fraud detection and prevention computing platform may comprise one or more computing devices and/or other computer components (e.g., processors, memories, communication interfaces). If the card issuer 140 determines to approve or deny the transactions, the card issuer 140 may send a message to the transaction authorization networks 130A-130N indicating the approval or denial of the transactions. The transaction authorization networks 130A-130N may send a message to the merchants 120 indicating the approval or denial of the transaction.

In some embodiments, a fraud detection and prevention computing platform of the card issuer 140 may be implemented in a cloud-based environment and/or communicate with the cloud server 142 for determining whether to approve or deny the authorization attempts. The cloud server 142 may communicate with the fraud detection and prevention computing platform for the processing of the authorization attempts. For example, the cloud server 142 may be used to facilitate the queries for transaction information (e.g., authorization attempts information) so that high-volume incoming authorization attempts may be efficiently processed. The cloud server 142 may include one or more computing devices and/or other computer components. In some implementations, the cloud server 142 may be a private (e.g., enterprise) cloud, a hybrid cloud, and/or a public cloud. The cloud server 142 may comprise one or more databases that store the authorization attempts and the information associated with the merchants 120. For example, the databases may store a safe list that comprises trusted merchants (e.g., uncompromised merchants) and a block list that comprises compromised merchants (e.g., merchants that are or may be subject to malicious card testing).

Computing environment 100 also may include one or more networks, which may interconnect one or more of the user devices 110A-110N, the merchants 120, the transaction authorization networks 130A-130N, the card issuer 140, the cloud server 142, and/or one or more other systems which may be associated with the card issuer 140, with one or more other systems, public networks, sub-networks, and/or the like. The one or more networks may be the Internet. Other networks, including private intranets, corporate networks, local area networks (LAN), wide area networks (WAN), metropolitan area networks (MAN), wireless networks, personal networks (PAN), may also or alternatively be used.

FIG. 2 depicts example hardware elements of a computing device in accordance with one or more example embodiments. The computing device (e.g., a fraud detection and prevention computing platform comprised in the card issuer 140) may comprise various network devices (e.g., nodes) 203, 205, 207, and 209 that are interconnected via a WAN 201, such as the Internet. Other networks may also or alternatively be used, including private intranets, corporate networks, LANs, wireless networks, PAN, and the like. The network 201 is for illustration purposes and may be replaced with fewer or additional computer networks. A LAN may have one or more of any known LAN topology and may use one or more of a variety of different protocols, such as Ethernet. The network devices 203, 205, 207, 209 and other devices may be connected to one or more of the networks via twisted pair wires, coaxial cable, fiber optics, radio waves or other communication media.

The term “network” as used herein refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The network devices may include a data server 203, a web server 205, and client computers 207, 209. The data server 203 may provide overall access, control and administration of databases and control software for performing one or more illustrative aspects described herein. The data server 203 may be connected to the web server 205 through which users interact with and obtain data as requested. Alternatively, the data server 203 may act as a web server itself and be directly connected to the Internet. The data server 203 may be connected to the web server 205 through the network 201 (e.g., the Internet), via direct or indirect connection, or via some other network. Users may interact with the data server 203 using remote computers 207, 209, e.g., using a web browser to connect to the data server 203 via one or more externally exposed web sites hosted by web server 205. The client computers 207, 209 may be used in concert with the data server 203 to access data stored therein, or may be used for other purposes. For example, from the client device 207 a user may access the web server 205 using an Internet browser or by executing a software application that communicates with the web server 205 and/or the data server 203 over a computer network (such as the Internet).

Servers and applications may be combined on the same physical machines, and retain separate virtual or logical addresses, or may reside on separate physical machines. FIG. 2 illustrates just one example of a network architecture that may be used, and those of skill in the art will appreciate that the specific network architecture and data processing devices used may vary, and are secondary to the functionality that they provide, as further described herein. For example, services provided by the web server 205 and the data server 203 may be combined on a single server.

Each network devices 203, 205, 207, 209 may be any type of known computer, server, or data processing device. The data server 203, e.g., may include a processor 211 controlling overall operation of the data server 203. The data server 203 may further include RAM 213, ROM 215, a network interface 217, an input/output (I/O) interfaces 219 (e.g., keyboard, mouse, display, printer, etc.), and memory 221. The I/O 219 may include a variety of interface units and drives for reading, writing, displaying, and/or printing data or files. The memory 221 may further store operating system software 223 for controlling overall operation of the data server 203, a control logic 225 for instructing the data server 203 to perform aspects described herein, and other application software 227 providing secondary, support, and/or other functionality which may or may not be used in conjunction with other aspects described herein. The control logic may also be referred to herein as the data server software 225. Functionality of the data server software may refer to operations or decisions made automatically based on rules coded into the control logic, made manually by a user providing input into the system, and/or a combination of automatic processing based on user input (e.g., queries, data updates, etc.).

The memory 221 may also store data used in performance of one or more aspects described herein, including a first database 229 and a second database 231. In some embodiments, the first database may include the second database (e.g., as a separate table, report, etc.). That is, the information can be stored in a single database, or separated into different logical, virtual, or physical databases, depending on system design. The network devices 205, 207, 209 may have similar or different architecture as described with respect to the device 203. Those of skill in the art will appreciate that the functionality of the data server 203 (or the device 205, 207, 209) as described herein may be spread across multiple data processing devices, for example, to distribute processing load across multiple computers, to segregate transactions based on geographic location, user access level, quality of service (QoS), etc.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

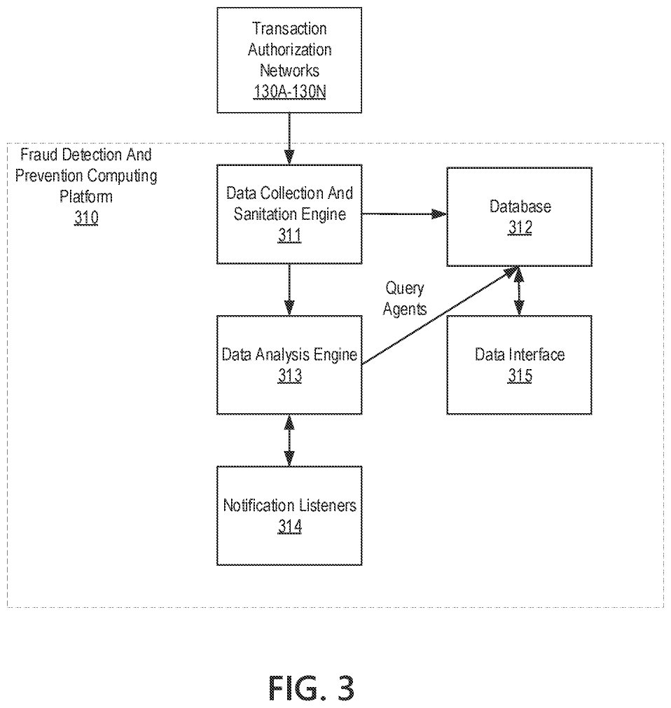

Having discussed illustrative computing devices that may be used to implement one or more aspects, discussion will now turn to a fraud detection and prevention computing platform that reviews authorization attempts at a merchant level. FIG. 3 depicts example components of a computing platform in accordance with one or more example embodiments. In FIG. 3, a fraud detection and prevention computing platform 310 (e.g., the fraud detection and prevention computing platform of the card issuer 140 described in connection with FIG. 1) may comprise one or more components and/or computing devices that perform the methods described herein. For example, the fraud detection and prevention computing platform 310 may comprise a data collection and sanitation engine 311, a database 312, a data analysis engine 313, one or more notification listeners 314, and a data interface 315.

Each of the data collection and sanitation engine 311, the database 312, the data analysis engine 313, the one or more notification listeners 314, and the data interface 315 may comprise one or more software modules. The one or more software modules may be collections of code or instructions stored on a media (e.g., the first database 229, the second database 231) that represent a series of machine instructions (e.g., program code). The one or more software modules may also include one or more hardware components. One or more aspects of an example algorithm may be performed by the hardware components (e.g., circuitry) itself, rather than as a result of an instructions.

The data collection and sanitation engine 311 may comprise one or more application programming interfaces (APIs). The APIs may be called by one or more of the transaction authorization networks 130A-130N. For example, one or more of the transaction authorization networks 130A-130N may submit real-time or near real-time authorization attempts via one or more hypertext transfer protocol (HTTP) calls to a dedicated API. Also or alternatively, one or more of the transaction authorization networks 130A-130N may periodically submit authorization attempts (e.g., in batches) via one or more HTTP calls to a dedicated API. Different transaction authorization networks 130A-130N may utilize a different method of submitting authorization attempts to the data collection and sanitation engine 311. The data collection and sanitation engine 311 may receive the authorization attempts sent by the one or more of the transaction authorization networks 130A-130N. The received authorization attempts may be in an extensible markup language (XML) format or other suitable formats. Each authorization attempt may correspond to an attempted transaction (e.g., valid transaction, invalid transaction) and may be associated with a respective merchant of the merchants 120 and a respective user account of a plurality of user accounts. A user account may be a stored account associated with a cardholder (e.g., an authorized user) of a payment card. A user account may comprise a username, password, card information, and other information related to the user.

The data collection and sanitation engine 311 may perform one or more pre-processing operations on the received authorization attempts. For example, the one or more pre-processing operations may comprise one or more data sanitation operations. The data collection and sanitation engine 311 may sanitize the data associated with the authorization attempts by, for example, stripping or removing any sensitive information (e.g., date of birth, social security number, address, phone number) from the authorization attempts. Different data sanitization methods may be used. For example, heuristic-based methods, machine learning-based methods, and/or k-source anonymity-based data cleaning methods may be used to sanitize the data. Also or alternatively, the data collection and sanitation engine 311 may implement one or more encryption techniques to protect sensitive attributes. For example, a security key (e.g., a private key) may be generated to encrypt the sensitive attributes. The data collection and sanitation engine 311 may choose to erase or delete the security key to ensure that the sensitive attributes might not be accessed.

The data collection and sanitation engine 311 may also normalize the data. For example, in order to allow the data collection and sanitation engine 311 and the data analysis engine 313 to function with multiple data sources (e.g., the transaction authorization networks 130A-130N). The data collection and sanitation engine 311 may normalize the received authorization attempts into a common transaction representation by, for example, structuring a database (e.g., the database 312) to store the data in accordance with database integrity constraints (e.g., data form rules). After normalizing the data associated with the authorization attempts, the data stored in the database may be queried using standard language (e.g., standard query language (SQL)).

The database 312 may store the data processed by the data collection and sanitation engine 311 (e.g., normalized data associated with the authorization attempts). The processed data may be stored separate from all other data and may be encrypted. Subsequent referral to the processed data may be performed through tokens corresponding to a respective payment card associated with the respective processed data. The processed data may be stored in a common storage mechanism. For example, data associated with different merchants may be marked appropriately but allowed to comingle in the database 312.

The data analysis engine 313 may be configured to analyze the processed data stored in the database 312 to identify fraudulent activities at a merchant level. Identifying compromised merchants instead of only individual payment cards may increase the likelihood of preventing current and future fraudulent activities because fraudulent users may tend to use the same merchants for card testing. The data analysis engine 313 may determine one or more notification rules for the identification of potential enumeration attacks and account testing attacks and of compromised merchants and/or individual user accounts due to the enumeration attacks and/or account testing attacks. The notification rules may be associated with transactions for one or more merchants across multiple user accounts and/or cards. Because fraudulent actors may funnel card testing attempts through multiple of merchants and users, the authorization attempts on one merchant may be associated with more than one user account.

Many types of notification criteria may be used. Embodiments of the present disclosure may implement rules based on one or more of these criteria, or any combination thereof. For example, the notification rules may comprise a rule based on specific velocity criteria because, for example, a significantly high number of authorization attempts on a merchant during a short time interval may indicate that the merchant is subject to fraudulent card testing. The notification rules may comprise criteria to test whether a total number of authorization attempts on a merchant, of the received authorization attempts during a time interval, satisfies a threshold (e.g., “identify merchants who have received 10 authorization attempts in the last 30 minutes”). The threshold may be set for each merchant or each merchant category (e.g., retail outlet services, transportation services, clothing stores, business services). In this way, not only are individual card transactions analyzed, but also the card transactions at a merchant level are analyzed. The threshold may be set for each merchant based on the expected transactions of each merchant (e.g., expected merchant authorization throughput patterns). For example, if the merchant is a small sandwich shop that is not expected to receive more than five authorization attempts between 9 am and 10 am on Tuesdays and the amount of each authorization attempt is not expected to exceed $50, two thresholds may be set for the merchant and/or similar merchants based on those expected activities (e.g., 5 authorization attempts before 9 am and 10 am on Tuesdays, 2 authorization attempts exceeding $50). In some examples, a same threshold may be set for each merchant (e.g., a threshold number of zero-dollar authorization attempts).

Also or alternatively, the notification rules may be associated with a count of transaction declines and/or transaction decline reasons. For example, the notification rules may comprise criteria to test whether a merchant has a threshold number of authorization attempts that are declined (e.g., determining whether a total number of authorization attempts on a merchant that are declined, of the received authorization attempts, satisfies the threshold number). An example notification rule may be “merchants who have received 100 invalid authorization attempts in the last 30 minutes.” These authorization attempts may be declined by the transaction authorization networks as invalid based on invalid card numbers, expiration dates, card security codes or any combination thereof, for example, but also for other reasons. The notification rules may comprise criteria to test whether a merchant has a threshold number of authorization attempts with specific suspicious decline reasons (e.g., determining whether a total number of authorization attempts on a merchant that are declined based on a particular decline reason, of the received authorization attempts, satisfies the threshold number). The rule criteria may identify the specific suspicious decline reasons that cause a transaction attempt to satisfy the rule, such as limiting the rule to invalid card numbers, expiration dates, card security codes or any combination thereof (for example).

Also or alternatively, the notification rules may be associated with a same amount. For example, the notification rules may comprise determining whether the merchant has received a threshold number of authorization attempts for the same amount (e.g., determining whether a total number of authorization attempts for a given value on a merchant, of the received authorization attempts, satisfies the threshold number).

Also or alternatively, the notification rules may be associated with a zero amount. For example, the notification rules may comprise determining whether the merchant has received a threshold number of authorization attempts for the zero amount (e.g., determining whether a total number of authorization attempts for $0.00 on a merchant, of the received authorization attempts, satisfies the threshold number).

Also or alternatively, the notification rules may be associated with a web address (e.g., uniform resource locator (URL)). For example, the notification rules may comprise determining if the merchant name contains a web address and/or has a threshold percentage of authorization attempts with suspicious decline reasons.

Also or alternatively, the notification rules may be associated with whether any authorization attempts for the merchant has ever been received. For example, the notification rules may comprise determining whether this is the first time identifying a transaction with this merchant (e.g., whether a merchant is associated with any prior authorization attempts) and whether the merchant is now submitting a threshold number of authorization attempts.

Also or alternatively, the notification rules may be associated with a change in a pattern of the authorization attempts (e.g., significant deviations from cardholder spending patterns, significant deviations from expected merchant authorization throughput patterns). For example, the notification rules may comprise determining whether a change and/or a rate of change in a number of authorization attempts on a merchant received during a time period satisfies a threshold.

Also or alternatively, the notification rules may comprise aggregate notification rules. The aggregate notification rules may be associated with authorization attempts across multiple merchants. Because fraudulent users may perform enumeration attacks on multiple merchants and test the same cards on multiple merchants, the aggregate notification rules may identify the same user accounts and/or card information that have been used for card testing, and identify multiple merchants that are compromised. For example, an aggregate notification rule may comprise a threshold number of authorization attempts on each of a plurality of merchants during a time interval and a threshold number of same user accounts that have been used for the authorization attempts on the each of a plurality of merchants. This aggregate notification rule may be satisfied if (a) there are at least a threshold number of authorization attempts on each of a plurality of merchants during a time interval, and (b) the authorization attempts comprise at least a threshold number of same user accounts associated with the each of a plurality of merchants. The aggregate notification rule may also consider the timing between the authorization attempts across the multiple merchants. A short time window between the authorization attempts across multiple merchants may suggest that the multiple merchants are compromised. Additionally, the aggregate notification rule may consider the compromised history of the merchants (e.g., whether the merchant has been compromised before, how often the merchant has been compromised). For example, if a merchant has been subject to a previous enumeration attack, then the threshold number of authorization attempts on that merchant during a time interval may be adjusted to be lower than the threshold number for other similar merchants.

The aggregate notification rule may be applied in combination with any other notification rule(s) described herein. For example, the data analysis engine 313 may determine whether a first plurality of authorization attempts satisfies a notification rule (e.g., different from the aggregate notification rule). The data analysis engine 313 may then determine whether the first plurality of authorization attempts itself or in combination with other received authorized attempts, satisfies an aggregate notification rule.

Also or alternatively, the data analysis engine 313 may consider a variety of other notification rules and/or factors in analyzing the processed data. For example, the data analysis engine 313 may consider one or more of geo-location data of the authorization attempts, geo-location data of the account/cardholder, whether a merchant is known (e.g., whether a merchant is associated with any prior authorization attempts), a number of attacks the card has been involved in, a number of authorizations attempted on a card in an attack or series of attacks as compared to predicted number of authorizations, a number of core card/account components (e.g., card/account number, card security code, expiration date) that have been compromised as a result of testing attacks, a merchant category, a card/account holder's compromised history (e.g., how often the card/account holder becomes compromised), and/or indicators a merchant is fraudulent (e.g., certain web address naming conventions, unreadable merchant names).

Also or alternatively, the data analysis engine 313 may utilize one or more machine learning techniques to analyze the processed data. For example, the database analysis engine 313 may utilize one or more machine learning approaches to identify fraud patterns in the processed data. The one or more machine learning models utilized by the data analysis engine 313 may take the form of one or more supervised and/or unsupervised models. The one or more machine learning models may be tailored for each specific merchant. Exemplary machine learning models or algorithms may comprise random forest model, support vector machines, neural networks, clustering models, deep learning models, Bayesian algorithms, and/or reinforcement learning models.

Based on the one or more notifications rules, the data analysis engine 313 may generate one or more queries to check the notification rules against the database 312. A database query may be generated based on a respective notification rule and may be configured to retrieve information corresponding to a first plurality of authorization attempts. The first plurality of authorization attempts may correspond to a merchant and a first plurality of user accounts. If the notification rule is an aggregate notification rule, a database query may be configured to retrieve information corresponding a first plurality of authorization attempts corresponding to a first merchant and a first plurality of user accounts, a second plurality of authorization attempts corresponding to a second merchant and a second plurality of user accounts, and/or additional authorization attempts corresponding to additional merchants and additional user accounts.

The data analysis engine 313 may use query agents (e.g., software agents) to query the data in the database 312 to determine if one or more notification rules are satisfied. The query may be configured to retrieve a plurality of authorization attempts corresponding to a merchant and a plurality of user accounts. The query agents may use SQL or other query languages to query the data in the database 312 and/or data arriving in events or event streams. If the query agents query the data in event streams, software tools such as Apache Kafka may be used to temporarily store the events and process the events. The query agents may query the database and return the results based on the notification rules. An example SQL function for a query is as follows:
SELECT COUNT(authorization attempts)
FROM Merchant A
WHERE time condition.

The data analysis engine 313 may determine an order (e.g., priority) of applying a plurality of notification rules to the authorization attempts. For example, the data analysis engine 313 may determine that a first database query may be generated and executed based on a first notification rule and a second database query may be generated and executed based on a second notification rule. In an example, if both the notification rules are satisfied, the data analysis engine 313 may determine that no more database queries may need to be generated and executed. But if only one of the first notification rule and the second notification rule is satisfied, the data analysis engine 313 may generate one or more additional database queries based on additional notification rules.

The data analysis engine 313 may determine whether a notification should be generated and/or output based on whether a notification rule is satisfied. Based on the query results, the data analysis engine 313 may generate one or more notifications. A notification may be generated based on determining that a plurality of authorization attempts on a merchant satisfies a notification rule. A notification may provide a signal to one or more notification listeners 314 that a compromised merchant has been identified. Based on the generated notification, the listeners 314 (and/or data analysis engine 313) may determine a suspicious status for a corresponding merchant. Listeners 314 may receive multiple notifications generated by the data analysis engine 313, and may apply weightings and/or other criteria to determine whether the multiple notifications, corresponding rules broken, and the activity associated with the rule merits assigning a suspicious status to the merchant. For example, each notification and/or rule may be assigned a weight, and the listeners 314 may assign a suspicious status to the merchant when an aggregate weight of received notifications meets a threshold level.

Additionally and/or alternatively, a notification may be generated based on determining that a plurality of authorization attempts on a merchant satisfies a compound notification rule that aggregates multiple criteria. The compound notification rule may comprise assigning or otherwise determining weighting values (e.g., weighting factor) to different notification rules and determining whether a score threshold is satisfied. An aggregate score may be determined based on whether one or more of the notification rules are satisfied and the corresponding weighting values. Some notification rules may be assigned a higher weighting value than other notification rules. For example, a first notification rule—whether a number of invalid authorization attempts on a merchant satisfies a threshold during a time interval—may be assigned a higher weighting value than other notification rules. As the data analysis engine 313 determines that individual criteria of the compound notification rule are met, it can tally an aggregate score based on the weight of that rule and/or the activity of the merchant that broke the rule, in some implementations. The data analysis engine 313 may generate a notification that the merchant should be assigned a suspicious status once the combined weight of the notification rules, that comprise the compound rule, that have been broken exceed a score threshold. The data analysis engine 313 may set one or more score thresholds for the merchants or each merchant category. If the determined score for a merchant exceeds a score threshold, the data analysis engine 313 may generate a notification and determine a suspicious status for the merchant. If the determined score for a merchant does not exceed the score threshold, no notification may be generated. In this case, the data analysis engine 313 may approve the authorization attempts associated with the merchant or flag the merchant as potentially suspicious and send an alert to an administrator to further determine whether the merchant is compromised.

The notification may indicate the merchant and/or the notification rule (or compound notification rule) that has been satisfied. The notification may also indicate the characteristics of the received authorization attempts. The characteristics may comprise at least one of the following: a total number of the received authorization attempts, one or more decline reasons for at least one of the received authorization attempts, a total number of the received authorization attempts for a same amount, a total number of the received authorization attempts for zero amount, an indication whether a name of the merchant comprises a web address, or an indication whether the merchant is associated with prior authorization attempts stored in the database, and/or a number of times that a user account associated with one of the received authorization attempts has been used to attempt to purchase an item from the merchant. Combinations thereof may also be included in the notifications, and the notifications may include other information associated with the merchant and/or authorization attempts as desired.

As discussed before, some aspects of the disclosure may improve the accuracy of identifying suspicious authorization attempts. In particular, the notification rules described herein may improve the accuracy of identifying suspicious authorization attempts and minimize false positives by analyzing the authorization attempts at a merchant level instead of at a card level. The data analysis engine 313 may use multiple notifications rules to minimize false positives while still achieving the required accuracy of identifying suspicious authorization attempts.

The notification listeners 314 (e.g., event listeners, event handlers) may be representative of a procedure or function configured to wait or listen for certain notifications generated by the data analysis engine 313. The notification listeners 314 may perform one or more actions based on the notifications. In some embodiments, a notification listener 314 may determine whether to apply a suspicious status for a merchant. In an example, if a notification is generated, the notification listener 314 may determine a suspicious status for a corresponding merchant. In addition, a notification listener 314 may respond to a specific notification type (e.g., a specific notification rule that is satisfied, a specific merchant that the notification outputs). Also or alternatively, multiple notification listeners 314 may correspond to a single notification and each notification listener 314 may be responsible for executing an action based on the notification that triggered it. The notification listeners 314 may be programmed to react to the corresponding notifications. For example, a notification may indicate that a notification rule has been satisfied. This notification may trigger a first corresponding notification listener 314 that marks the merchant as compromised in the database 312 (e.g., add the merchant to a block list), a second corresponding notification listener 314 that alerts a user about the change in status for the merchant, and/or a third corresponding notification listener 314 that creates a summary of transactions related to the merchant.

In some embodiments, a notification listener 314 might not automatically assign a suspicious status for a corresponding merchant based on receiving one notification. Instead, the notification listener 314 may wait for any additional notifications that may be generated and assign different weighting values to different notifications. Based on the number of notifications and the corresponding weighting value, the notification listeners 314 may determine whether to determine a suspicious status for a corresponding merchant. The notification listeners 314 may perform one or more actions based on the determined suspicious status of the merchant. For example, the notification listeners 314 may add the merchant to a block list. In some implementations, the notification itself indicates a decision by the data analysis engine 313 to add the merchant to the block list, and the notification listener 314 implements the block. In other aspects, the notification listeners 314 may apply suitable criteria to determine if a given notification, or set of notifications received, merits assigning a suspicious status to the merchant. Examples of actions are further described in connection with FIGS. 4, 5A-5C, and 6, and 7.

The data interface 315 may be configured to generate and/or output one or more interfaces for presentation. For example, the data interface 315 may comprise the generated notifications and the corresponding actions. Also or alternatively, the data interface 315 may generate a list of merchants that have been identified as suspicious for presentation to a user (e.g., a card issuer administrator, a merchant administrator, a transaction authorization network administrator) via a client device. The user may choose to block, trust, or ignore the notification for the respective merchant 120 via the interface. Users may be able to access and interact with data via electronic means that interact with the single API layer. These methods of access may take the form of a web page, a mobile application or even a machine-to-machine integration. The data interface 315 may also generate a report for a respective merchant 120. For example, the data interface 315 may notify the merchant of a number of fraudulent attempts on its website.

Having discussed a fraud detection and prevention computing platform that reviews authorization attempts at a merchant level, discussion will now turn to an illustrative event sequence for detecting and preventing suspicious payment card authorization attempts. FIG. 4 depicts an illustrative event sequence for detecting and preventing suspicious payment card authorization attempts in accordance with one or more example embodiments. In FIG. 4, the user devices 110A-110N may initiate one or more communication sessions between the user devices 110A-110N and the merchants 120. At step 411, one or more user devices 110A-110N may send authorization attempts to the merchants 120 via, for example, website(s) associated with the merchants 120. An authorization attempt may correspond to an attempted transaction (e.g., credit card payment transaction, debit card payment transaction, prepaid card payment transaction) and may be associated with a respective merchant of the merchants 120 and a respective user account of a plurality of user accounts. An authorization attempt may comprise a request for payment authorization. The request may comprise information associated with a payment card used for the transactions. For example, the request may comprise information indicating a corresponding transaction authorization network, an amount of the transaction, a name and/or category of the respective merchant, a name of the user account, a card number, an expiration date, a zip code associated with the user account, and/or a card security code.

The user devices 110A-110N may be used to initiate an enumeration attack on the merchants 120. The enumeration attack may comprise testing the validity of payment card information on the merchants 120. The enumeration attack may target only one merchant during a time interval. Alternatively, the enumeration attack may target multiple merchants at the same time or during substantially similar time intervals by, for example, testing a first plurality number of cards on a first merchant and testing a second plurality number of cards on a second merchant. For example, fraudulent users may program a plurality of computers to execute high-volume low-value transactions (e.g., $0.1) on the merchants 120. Fraudulent users may try different combinations of card numbers, expiration dates, and card security codes (e.g., correct card numbers but incorrect expiration dates, correct card numbers but incorrect card security codes). Based on the results of the low-value transactions, fraudulent users may obtain information indicating the correct combinations of card numbers, expiration dates, and/or card security codes. Fraudulent users may also rule out incorrect card numbers, expiration dates, and/or card security codes.

In addition, fraudulent users may execute a first plurality of low-value transactions on a first merchant during a first time interval and may execute a second plurality of low-value transactions on a second merchant during a second time interval. The first time interval and the second time interval may be the same or different. The first plurality of low-value transactions and the second plurality of low-value transactions may share one or more same card numbers, expiration dates, and/or card security codes. Many transaction monitoring systems and tools are unable to detect such fraudulent transactions. Some aspects of the disclosure describe detecting and preventing fraudulent transactions on one or more merchants.

At step 413, the merchants 120 may send the authorization attempts to the transaction authorization networks 130A-130N. For example, the merchants 120 may receive the authorization attempts from the user devices 110A-110N and forward the authorization attempts to corresponding transaction authorization networks 130A-130N. An authorization attempt may correspond to one of the transaction authorization networks 130A-130N and may need to be approved by both the corresponding transaction authorization network and the corresponding card issuer (e.g., the card issuer 140). The merchants 120 may determine a corresponding one of the transaction authorization networks 130A-130N for each authorization attempt based on the information associated with the authorization attempt. For example, the merchants 120 may extract transaction authorization network information in the authorization attempts and send the authorization attempts to the corresponding transaction authorization networks 130A-130N.

At step 415, the transaction authorization networks 130A-130N may review the authorization attempts and determine one or more actions for the authorization attempts. For example, the transaction authorization networks 130A-130N may determine whether to approve one, some, or all of the authorization attempts, and/or flag or otherwise indicate one, some, or all of the authorization attempts as suspicious.

The transaction authorization networks 130A-130N may determine if the information in the authorization attempts corresponds to the stored information (e.g., stored card information). For example, for each authorization attempt, one of the transaction authorization networks 130A-130N may determine whether the card information in the received authorization attempt (e.g., the card number, the expiration date, and the card security code) is correct based on the stored card information. Also or alternatively, for each authorization attempt, one of the transaction authorization networks 130A-130N may determine, for example, whether the card associated with the card number has been reported lost or stolen, whether the card is counterfeit, and/or whether the card has expired. The transaction authorization networks 130A-130N may determine one or more rules for determining whether to approve the authorization attempts. The rules may indicate, for example, that the transaction authorization networks 130A-130N may approve the received authorization attempts if the card information in the received authorization attempts matches the stored card information.

Based on the determination and one or more rules, the transaction authorization networks 130A-130N may determine one or more actions for the received authorization attempts. For example, the transaction authorization networks 130A-130N may flag or otherwise indicate authorization attempts as suspicious and allow other networks and/or devices (e.g., the card issuer 140) to determine whether to approve or deny the authorization attempts. The transaction authorization networks 130A-130N may generate information indicating that the authorization attempts are suspicious or not approved (e.g., reasons for the suspicious information, time of the receipt of the authorization attempts) based on the card information in the received authorization attempts. For example, the authorization networks 130A-130N may determine that an authorization attempt is suspicious or not approved because the expiration date associated with the authorization attempt is incorrect, but the card number and card security code associated with the authorization attempt are correct.

Also or alternatively, the transaction authorization networks 130A-130N may deny the authorization attempts if the card numbers associated with the authorization attempts are incorrect (e.g., the card number is nonexistent or restricted). The transaction authorization networks 130A-130N may generate denial information indicating that the authorization attempts are invalid (e.g., reasons for the denial, time of the receipt of the authorization attempts) based on the card information in the received authorization attempts.

Also or alternatively, the transaction authorization networks 130A-130N may approve (e.g., not flag or otherwise indicate that the authorization attempt is suspicious) the authorization attempts if the transaction authorization networks 130A-130N determine that the authorization attempts appear to be valid based on, for example, previous transactions associated with the authorization attempts and/or the stored card information. The transaction authorization networks 130A-130N may generate approval information (e.g., information indicating whether the authorization attempts are not suspicious, time of the approval, reasons for approval, potential reasons for denial) based on the approval or other actions/determinations of the authorization attempts. Even if the transaction authorization networks 130A-130N have approved the authorization attempts, the authorization attempts may also need to be approved by the corresponding card issuer(s).

At step 417, the transaction authorization networks 130A-130N may send the received authorization attempts and the determined one or more actions to the card issuer 140. For example, the transaction authorization networks 130A-130N may send the received authorization attempts and information associated with the received authorization attempts to the card issuer 140. As an example, the transaction authorization networks 130A-130N may send the received authorization attempts and the approval information to the card issuer 140. As another example, the transaction authorization networks 130A-130N may send the received authorization attempts, the information indicating that the authorization attempts are suspicious or not approved, and/or the denial information to the card issuer 140.

At step 419, the card issuer 140 (e.g., the fraud detection and prevention computing platform 310) may analyze the received authorization attempts for multiple user accounts and merchants, as has been described above with respect to FIG. 3. For example, the card issuer 140 may receive the authorization attempts and analyze the data associated with the received authorization attempts. In some examples, none of the received authorization attempts sent from the transaction authorization networks 130A-130N to the card issuer 140 has been flagged or identified as fraudulent, but some of the received authorization attempts may relate to a fraudulent attack on the merchants 120. Authorization attempts that were otherwise deemed valid, or invalid but not fraudulent, (e.g., by the transaction authorization networks 130A-130N) may be analyzed using the disclosed architecture and algorithms to identify previously undetected fraudulent attack. Because each authorization attempt may correspond to an attempted transaction and may be associated with a respective merchant of the merchants 120 and a respective user account of a plurality of user accounts, the card issuer 140 may analyze the data associated with the received authorization attempts for multiple user accounts and merchants at the same time. Based on one or more notification rules, the card issuer 140 may generate one or more database queries. In an example, a database query may be generated based on a respective notification rule and may be configured to retrieve information corresponding to the received authorization attempts. A plurality of the received authorization attempts may correspond to a merchant and a plurality of user accounts.

At step 421, the card issuer 140 may apply rule(s) to determine a suspicious status of the merchants. For example, the data analysis engine 313 may determine one or more notification rules for the identification of compromised merchants. The card issuer 140 may apply one or more notification rules to determine whether each merchant is compromised. Based on the query results (e.g., whether the notification rule is satisfied), the card issuer 140 may determine a suspicious status of the merchant.

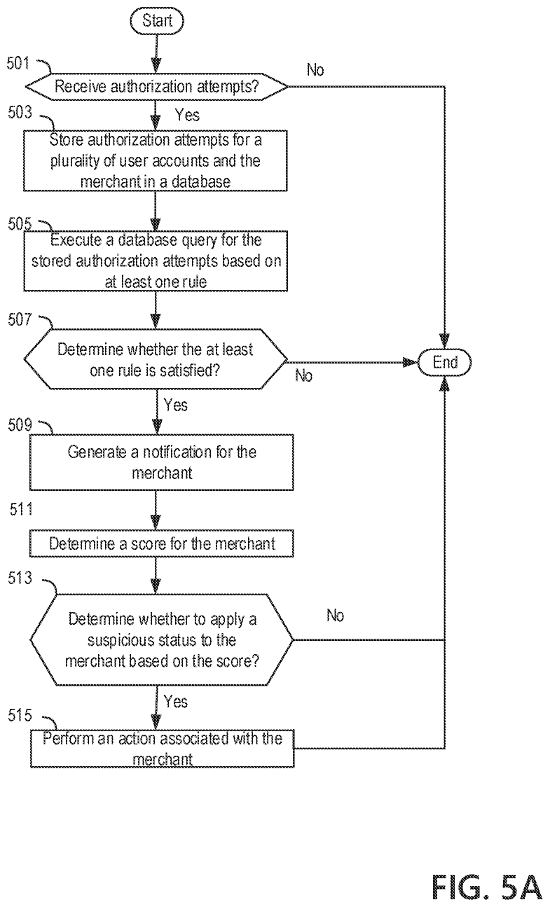

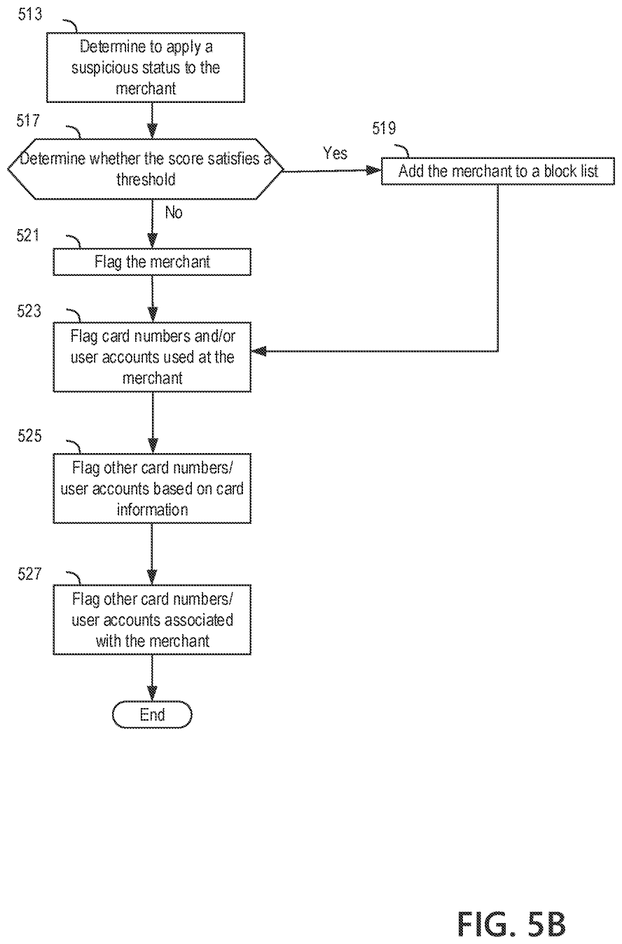

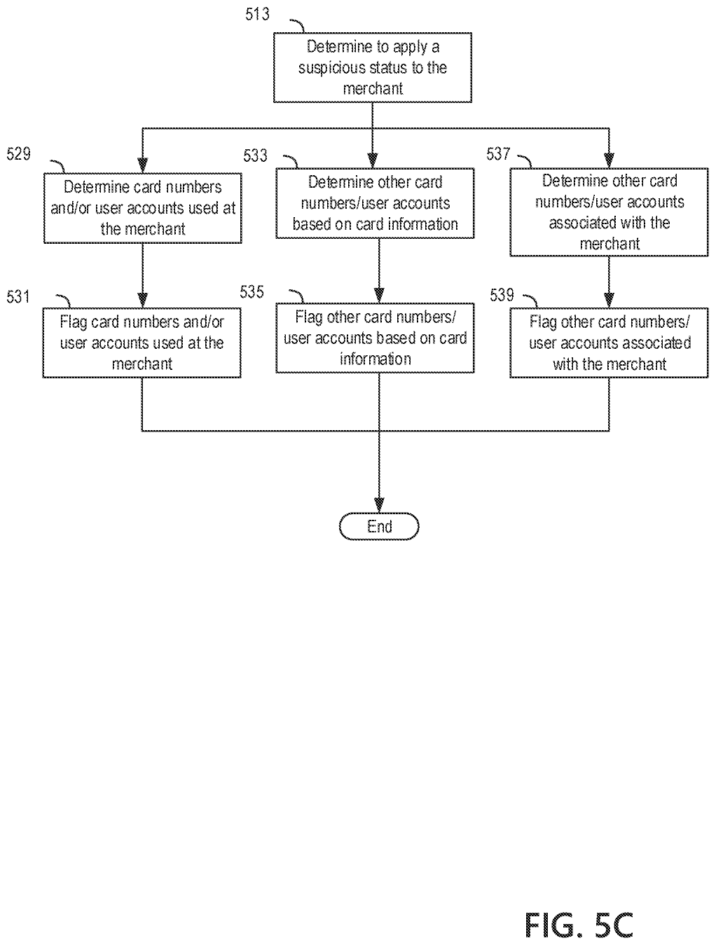

At step 423, the card issuer 140 may perform one or more actions based on the notification rules. The actions may comprise, for example, denying (e.g., prevent the withdrawal of the funds associated with the user accounts) one, some, or all of the received authorization attempts corresponding to the compromised merchant and future authorization attempts corresponding to the compromised merchant, adding the compromised merchant to a block list that comprises a list of merchants with a suspicious status, and/or generating an alert indicating the determined suspicious status of the compromised merchant. The card issuer 140 may send the alert to one or more of the following: a card issuer administrator, one or more transaction authorization networks 130A-130N that reviewed the authorization attempts associated with the compromised merchant, other transaction authorization networks 130A-130N, the compromised merchant, and/or other business entities or administrators. Additional examples of actions are further described in connection with FIGS. 5A-5C, 6, and 7.

The card issuer 140 may comprise a database (e.g., the database 312) that stores the block list and a safe list. The block list may comprise merchants that are not trusted by the card issuer 140. The block list may be constantly updated by the card issuer 140. For example, the card issuer 140 may have previously identified compromised merchants and may have added the compromised merchants to the block list. If a merchant is included in the block list, the card issuer 140 may determine that the merchant is not trusted and may deny any transactions associated with the merchant. But if the card issuer 140 has received a message (e.g., a notification) from a merchant in the block list or another entity (e.g., a merchant acquiring bank) indicating that additional security measures (e.g., a previous software bug has been fixed, new payment authentication methods, previous errors associated with the merchant have been rectified) have been implemented to prevent the fraudulent transactions, the card issuer 140 may determine to remove the merchant from the block list.

The safe list may comprise merchants that are trusted by the card issuer 140. For example, the card issuer 140 may add a merchant to the safe list if the card issuer 140 determines that none of the notification rules is satisfied during a time period. As another example, the card issuer 140 may determine that certain merchants that have robust payment security systems (e.g., Amazon, Netflix, Google) are trusted regardless of whether any of the notification rules is satisfied. These trusted merchants may be added to the safe list. The safe list may be constantly updated by the card issuer 140. If a merchant is included in the safe list, the card issuer 140 may determine that the merchant can be trusted and may approve any authorization attempts associated with the merchant. Alternatively, the card issuer 140 may set different thresholds for determining whether the notification rules are satisfied and/or a suspicious status of the merchant. For example, if a notification rule comprises a threshold number of authorization attempts on a merchant during a time interval, the threshold number of authorization attempts on a first merchant in a safe list is different from (e.g., higher than) the threshold number of authorization attempts on a second merchant that is not in the safe list. The card issuer 140 may also determine if there is a significant change in the pattern (e.g., a change in a number of received authorization attempts during a time period) of the received authorization attempts corresponding to the merchant in the safe list. If a merchant is not included in the safe list or the block list, the card issuer 140 may analyze the received authorization attempts based on one or more notification rules, as described herein.

At step 425, the user devices 110A-110N may send additional authorization attempts to the merchant 120. An additional authorization attempt may comprise a request for payment authorization and the request may comprise information associated with a payment card used for the transactions. The additional authorization attempts may be associated with one or more same merchants that previously received the authorization attempts. As an example, fraudulent users may use the same user devices or different user devices to test additional card information on the same or different merchants.

At step 427, the merchants 120 may send the additional authorization attempts to the transaction authorization networks 130A-130N. For example, the merchants 120 may receive the additional authorization attempts from the user devices 110A-110N and forward the additional authorization attempts to corresponding transaction authorization networks 130A-130N.

At step 429, the transaction authorization networks 130A-130N may send the additional authorization attempts and approval information to the card issuer 140. For example, the transaction authorization networks 130A-130N may review the additional authorization attempts and determine one or more actions for the additional authorization attempts. For example, the transaction authorization networks 130A-130N may generate information for the additional authorization attempts based on the determined one or more actions.

At step 431, the card issuer 140 may deny the additional authorization attempts based on the block list. For example, if the additional authorization attempts are associated with one or more merchants in the block list, the card issuer 140 may deny the additional authorization attempts. The card issuer 140 might not analyze the additional authorization attempts based on one or more notification rules, thus increasing the processing speed of the authorization attempts. After denying the additional authorization attempts, the card issuer 140 may generate an alert indicating that the additional authorization attempts have been denied, and/or the reasons for the denial.

Having discussed an illustrative event sequence for detecting and preventing suspicious payment card authorization attempts, discussion will now turn to a method for detecting and preventing suspicious payment card authorization attempts. FIGS. 5A-5C depict an illustrative method for detecting and preventing suspicious payment card authorization attempts associated with one merchant in accordance with one or more example embodiments. The description of FIGS. 5A-5C includes examples of computing devices that may perform various steps. However, any or all of those steps (and/or other steps) may be performed by one or more other computing devices. One or more steps may be combined, sub-divided, omitted, or otherwise modified, and/or added to other steps. The order of steps may be modified.

Referring to FIG. 5A, at step 501, a computing device (e.g., the card issuer 140, the fraud detection and prevention computing platform 310) having at least one processor, a communication interface, and memory may receive a plurality of authorization attempts. For example, the computing device may receive a plurality of authorization attempts from one or more transaction authorization networks (e.g., the transaction authorization networks 130A-130N). The received authorization attempts may be associated with one or more card numbers and/or user accounts. Each authorization attempt may correspond to an attempted transaction and may be associated with a respective merchant (e.g., the merchant 120) of a plurality of merchants and a respective user account of a plurality of user accounts. The received authorization attempts may be part of an enumeration attack, aiming to determine the validity of card information. But the received authorization attempts may have not been flagged by the one or more transaction authorization network as having a suspicious status. Also or alternatively, the received authorization attempts may comprise a first plurality of authorization attempts denied by an operator of the one or more transaction authorization networks and a second plurality of authorization attempts approved by the operator of the one or more transaction authorization network. The plurality of authorization attempts may be received by more than one transaction authorization network and the more than one transaction authorization network may have different operators. In an example, none of the operators or transaction authorization networks may have identified the plurality of authorization attempts as having a suspicious status or associated at least some of the plurality of authorization attempts to a fraudulent attack on a merchant. The computing device may set a time period (e.g., time interval) for periodically receiving the authorization attempts. The time period may be set for each merchant or each type of merchant (e.g., based on the size of the merchant, based on the annual revenue of the merchant). If the computing device does not receive any authorization attempt during a time period, the method may proceed to the end.

At step 503, the computing device may store the authorization attempts for a plurality of user accounts and the merchant in a database (e.g., the database 312). Each of the plurality of authorization attempts may correspond to an attempted transaction and may be associated with a respective merchant of a plurality of merchants (e.g., the merchant 120) and a respective user account of a plurality of user accounts.

At step 505, the computing device may generate and execute a database query for the stored authorization attempts based on at least one notification rule. The computing device may determine a plurality of notification rules and may generate one or more database queries based on the notification rules (e.g., criteria of the notification rules) and/or based on patterns corresponding to the notification rules. The database queries may request and/or retrieve data from a database (e.g., the database 312) that comprises information of the stored authorization attempts based on at least one notification rule. For example, a database query may be configured to retrieve a first plurality of authorization attempts corresponding to a first merchant and a first plurality of user accounts. The database query may be generated based on first criteria corresponding to a first notification rule of a plurality of notification rules.

The computing device may aggregate the received authorization attempts for one merchant based on the database query. For example, the computing device may aggregate a first plurality of received authorization attempts of the total received authorization attempts if the database query is configured to retrieve the first plurality of received authorization attempts that is associated with a first merchant. The computing device may set one or more aggregation time periods and start time points for the first merchant.

At step 507, the computing device may determine whether first criteria (e.g., one or more criteria) of at least one notification rule is satisfied. For example, based on the retrieved data from the database queries, the computing device may determine whether first criteria of at least one notification rule is satisfied. The first criteria of the first notification rule may be associated with a first merchant. For example, if the first criteria of the notification rule is determining whether a number of the authorization attempts on a first merchant satisfies a threshold during a time interval, the computing device may determine whether the retrieved data satisfies the first criteria of the notification rule by counting the number of authorization attempts on the first merchant during a time interval. If the computing device determines that the first criteria of at least one notification rule is satisfied, step 509 may be performed. If the computing device determines that none of the criteria of any notification rules is satisfied, the method may proceed to the end.

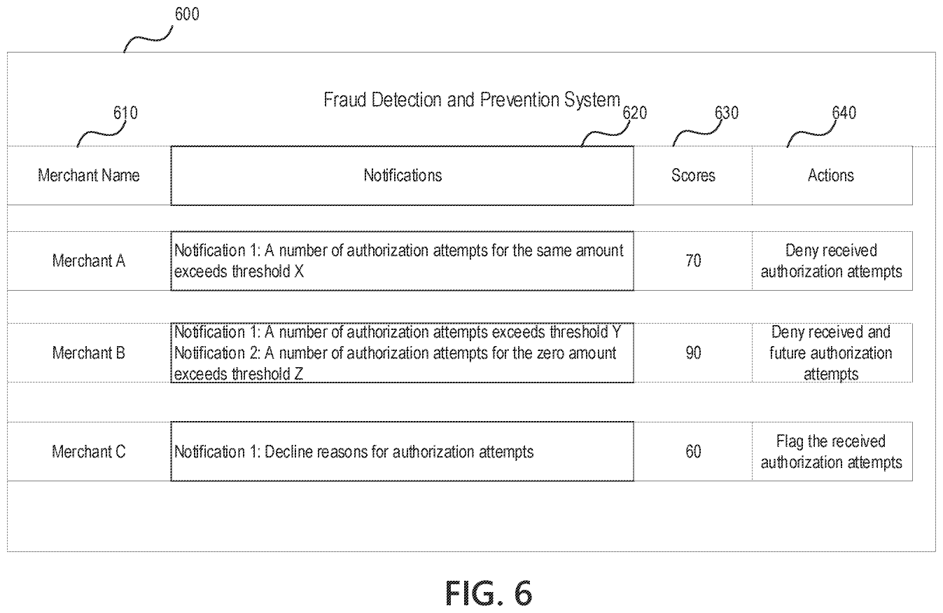

At step 509, the computing device may generate a notification for the merchant. If the computing device determines that at least one notification rule is satisfied, the computing device may generate a notification for a merchant based on the at least one notification rule. For example, if the computing device determines that a plurality of authorization attempts on a first merchant satisfies the first criteria of a first notification rule, the computing device may generate a notification based on determining that the plurality of authorization attempts on the first merchant satisfies the first notification rule. The notification may indicate a suspicious status for the first merchant. The notification may comprise information indicating the first merchant, and/or the first notification rule. The computing device may generate another notification based on determining that the plurality of authorization attempts on the first merchant satisfies second criteria of a second notification rule. The notification may comprise information indicating the first merchant, and/or the second notification rule. The computing device may output the notification for the first merchant via a user device, which will be described in connection with FIG. 6.

At step 511, the computing device may determine a score for the merchant. The score may indicate the likelihood that the merchant has been compromised or to be compromised. For example, if the computing device has generated one or more notifications associated with a merchant, the computing device may determine a score based on the notification rules (e.g., a number of the notification rules that are satisfied and which notification rules are satisfied) and/or other rules. In some examples, the computing device may generate multiple notifications based on a determination that multiple notification rules are satisfied. The computing device may determine an aggregate score by, for example, applying a respective weighting value to each of the notifications, or each notification rule. Also or alternatively, the computing device may determine a score and/or a suspicious status for the merchant based on the output of a machine learning model trained to correlate the plurality of notification rules with a score or a suspicious status of a merchant.

At step 513, the computing device may determine whether to apply a suspicious status to a merchant based on the score. Alternatively, the computing device may determine to apply a suspicious status to a merchant if one or more notifications are generated, or if one or more criteria of notification rules are satisfied. For example, the computing device may determine to apply a suspicious status to a merchant if at least one notification is generated (e.g., one notification rule is satisfied). As another example, the computing device may generate, based on determining that the first plurality of authorization attempts satisfies first criteria of a first notification rule, a notification indicating a suspicious status for the first merchant, as described above.

Based on the score and one or more score thresholds (e.g., a predetermined score threshold), the computing device may determine whether to apply a suspicious status to the merchant. For example, if the score of a merchant satisfies a first threshold (e.g., 60) for the merchant, the computing device may determine to apply a suspicious status to the merchant. In another example, the computing device may determine whether to apply a suspicious status to the merchant based on determining that the first plurality of authorization attempts corresponding to the first merchant satisfies the criteria of one or more notification rule. If the computing device determines to apply a suspicious status to the merchant, step 515 may be performed. If the computing device determines to not apply a suspicious status to the merchant, the method may proceed to the end.

The determined suspicious status of the merchant may help identify compromised user accounts and/or payment cards. Based on the suspicious status of the merchant, the computing device may determine that the user accounts associated with the authorization attempts on the merchant have been compromised because fraudulent users may have attempted to use those user accounts to purchase items from the merchant. The fraudulent users may use those user accounts on a different merchant. Even if no notification rule is satisfied for that different merchant, the computing device may flag the authorization attempts associated with the compromised user accounts and/or deny future authorization attempts associated with the compromised user accounts.

In addition, the computing device may identify not-yet-issued cards that have likely been comprised or already compromised, generate an indication that the not-yet-issued user accounts are already compromised or likely-to-be compromised, and/or avoid issuing new cards with card information that have been tested before (e.g., card information associated with the compromised merchant). The card information may be complete card information (e.g., a combination of a full account number, card security code, and expiration date) or partial card information (e.g., a majority of card information with a few missing or incorrect numbers). If the complete card information of a card has been sent in an authorization attempt associated with a compromised merchant, the computing device may determine that card is already compromised and may avoid issuing a new card (or user account) with that card information. If the partial card information of a card has been sent in an authorization attempt associated with a compromised merchant, the computing device may determine a score for that card (e.g., based on a score for an associated merchant and/or the partial card information) and determine whether to avoid issuing a new card (or user account) with the partial card information based on the score. For example, if the score for the card is above a first threshold, the computing device may avoid issuing a new card that includes the partial card information. If the score for the card is below the first threshold and above a second threshold, the computing device may generate a flag indicating a suspicious status of the card and send a message comprising the flag to an administrator. The administrator may further determine whether to issue a new card that includes the partial card information. If the score for the card is below the second threshold, no action may be performed. Various other thresholds may be set and corresponding actions may be performed (or not performed) based on the thresholds.

At step 515, the computing device may perform an action associated with the merchant. For example, if the computing device determines to apply a suspicious status to the merchant, the computing device may perform one or more actions. The actions may comprise, for example, denying one, some, or all of the received authorization attempts corresponding to the merchant and future authorization attempts corresponding to the merchant, adding the merchant to a block list that comprises a list of merchants with a suspicious status, and/or generating an alert indicating the determined suspicious status of the merchant. The computing device may send the alert to one or more of the following: a card issuer administrator, one or more transaction authorization networks 130A-130N that reviewed the received authorization attempts associated with the compromised merchant, other transaction authorization networks 130A-130N, the compromised merchant, and/or other business entities or administrators. Further description of actions will be further described in connection with FIGS. 5B and 5C.

Referring to FIG. 5B, at step 513, the computing device may determine to apply a suspicious status to a merchant. This step may be the same as step 513 in FIG. 5A. For example, the computing device may determine to apply a suspicious status to a merchant if the score for the merchant satisfies a first threshold. As another example, the computing device may determine to apply a suspicious status to a merchant if the criteria of at least one notification rule is satisfied.

At step 517, the computing device may determine whether the score for the merchant satisfies a threshold (e.g., a second threshold different from the first threshold). For example, if the computing device determines that the score satisfies a second threshold (e.g., different from the first threshold for determining the suspicious status of the merchant) for the merchant (e.g., the score is not below the second threshold), the computing device may determine that the merchant is very likely to be compromised or has been compromised, and the method may proceed to step 519. If the computing device determines that the score does not satisfy a second threshold (e.g., the score is below the threshold), the method may proceed to step 521. Various other thresholds may be set and corresponding actions may be performed based on the thresholds.

As discussed above, the computing device may perform one or more actions based on the suspicious status of the merchant and/or the score of the merchant. For example, at step 519, the computing device may add the merchant to a block list. If the merchant is added to a block list, the received authorization attempts and all future transactions associated with the merchant may be blocked until the merchant is removed from the block list. The merchant may be on the block list for a predetermined time or until additional payment security measures are implemented. The computing device may also determine whether any prior transactions associated with the merchant (e.g., transactions that occurred immediately before the received authorization attempts) should be analyzed, for example, based on the score of the merchant, even if the prior transactions may have been approved by the computing device. If the computing device determines that some prior transactions associated with the merchant may be suspicious, the computing device may send an alert to the one or more of the following: a cardholder, a card issuer administrator, one or more transaction authorization networks 130A-130N that reviewed the received authorization attempts associated with the compromised merchant, other transaction authorization networks 130A-130N, the compromised merchant, and/or other business entities or administrators. The alert may cause an actor (e.g., the cardholder, the card issuer administrator) to perform suitable actions to, for example, dispute the prior transactions. The method may proceed to step 523.

At step 521, if the score of the merchant does not satisfy a threshold (e.g., the score is above the first threshold and below a second threshold), the computing device may generate a flag indicating the determined suspicious status of the merchant and send a message comprising the flag to an administrator. The administrator may further determine whether to deny any of the received authorization attempts corresponding to the merchant. Various other thresholds may be set and corresponding actions may be performed based on the thresholds.

At step 523, the computing device may flag the card numbers and/or user accounts associated with the merchant. The computing device may identify the card numbers and/or user accounts associated with the merchant as suspicious, and/or deny one of, some of, or all of the received authorization attempts corresponding to the merchant. Even though the computing device has applied a suspicious status to a merchant, the computing device might not automatically deny all the authorization attempts corresponding to the merchant. Instead, the computing device may analyze the characteristics of each one of the received authorization attempts corresponding to the merchant and determine whether any of the received authorization attempts corresponding to the merchant should be denied. The characteristics of each one of the received authorization attempts may confirm that an enumeration attack actually occurred. The characteristics of one of the received authorization attempts may comprise at least one of the following: a time of receipt of the one of the received authorization attempts, a time interval between two received authorization attempts, an expected user activity for the user account associated with the one of the received authorization attempts, a card security code associated with the one of the received authorization attempts, an expiration date of a payment card associated with the one of the received authorization attempts, and/or a number of times that a user account associated with the one of the received authorization attempts has been used to attempt to purchase an item from the merchant. For example, if the same user account associated with multiple received authorization attempts has been used to attempt to purchase an item from the merchant many times and the time interval between each attempt is very short (e.g., less than 1 second), the computing device may confirm that an enumeration attack on the user account and the merchant actually occurred.

At step 525, the computing device may flag other card numbers/user accounts based on the card information associated with the received authorization attempts. For example, the computing device may determine at least another user account as being likely compromised. The another user account may not be one of the plurality of user accounts associated with the received authorization attempts. The computing device may determine the another user account based on a determination that the another user account and one of the plurality of user accounts share the same partial card information (e.g., a portion of the account number, same BIN, same IIN). For example, if one of the plurality of user accounts is associated with a specific business entity (e.g., indicated by the BIN), the computing device may determine that other user accounts associated with that business entity are likely compromised, even if those user accounts are not associated with the same merchant or the received authorization attempts. The computing device may apply additional rules to determine a subset of the other user accounts that are more likely to be compromised (e.g., same expiration date/year with one of the plurality of user accounts, same card security code with one of the plurality of user accounts).

At step 527, the computing device may flag other card numbers/user accounts based on the merchant. For example, the computing device may identify at least another user account that has been used at the merchant as suspicious, for example, because the merchant is compromised. The computing device may set a time period for identifying other user accounts based on the merchant. For example, the computing device may determine that all the user accounts that were used at the merchant within 1 hour of the first received authorization attempt of the received authorization attempts are compromised, even if some or all of those user accounts are valid and the transactions have been approved by the computing device. In this way, the computing device may identify additional potential compromised user accounts to avoid any potential further monetary losses. The method may proceed to the end.

Referring to FIG. 5C, at step 513, the computing device may determine to apply a suspicious status to a merchant. This step may be the same as step 513 in FIGS. 5A and 5B. For example, the computing device may determine to apply a suspicious status to a merchant if, for example, the criteria of at least one notification rule is satisfied. As another example, the computing device may determine to apply a suspicious status to a merchant if the score for the merchant satisfies a first threshold. Various actions may be performed after the computing device determines to apply a suspicious status to a merchant.

At step 529, the computing device may determine the card numbers and/or user accounts associated with the merchant. For example, the computing device may determine the card numbers and/or user accounts that have been used at the merchant in a predefined time period. The card numbers and/or user accounts may be used in connection with the received authorization attempts.

At step 531, the computing device may flag the determined card numbers and/or user accounts associated with the merchant. This step may be the same as step 523 in FIG. 5B. The computing device may identify the card numbers and/or user accounts associated with the merchant as suspicious, and/or deny one of, some of, or all of the received authorization attempts corresponding to the merchant. The method may proceed to the end.

At step 533, the computing device may determine other card numbers/user accounts based on the card information associated with the received authorization attempts. For example, the computing device may determine at least another user account as being likely compromised. The another user account may not be one of the plurality of user accounts associated with the received authorization attempts. The computing device may determine the another user account based on a determination that the another user account and one of the plurality of user accounts share the same partial card information (e.g., a portion of the account number, same BIN, same IIN). For example, if one of the plurality of user accounts is associated with a specific business entity (e.g., indicated by the BIN), the computing device may determine that other user accounts associated with that business entity are likely compromised, even if those user accounts are not associated with the same merchant or the received authorization attempts. The computing device may apply additional rules to determine a subset of the other user accounts that are more likely to be compromised (e.g., same expiration date/year with one of the plurality of user accounts, same card security code with one of the plurality of user accounts).

At step 535, the computing device may flag the determined other card numbers/user accounts based on the card information associated with the received authorization attempts. This step may be the same as step 525 in FIG. 5B. The computing device may identify the determined other card numbers/user accounts as suspicious, and/or deny one of, some of, or all of the prior and/or future authorization attempts associated with determined other card numbers/user accounts. The method may proceed to the end.

At step 537, the computing device may determine other card numbers/user accounts based on the merchant. For example, the computing device may identify at least another user account that has been used at the merchant as suspicious, for example, because the merchant is compromised. The computing device may set a time period for identifying other user accounts based on the merchant. For example, the computing device may determine that all the user accounts that were used at the merchant within 1 hour of the first received authorization attempt of the received authorization attempts are compromised, even if some or all of the user accounts are valid and the transactions have been approved by the computing device. In this way, the computing device may identify additional potential compromised user accounts to avoid any potential further monetary losses.

At step 539, the computing device may flag the determined other card numbers/user accounts based on the merchant. This step may be the same as step 527 in FIG. 5B. The computing device may identify the determined other card numbers/user accounts as suspicious, and/or deny one of, some of, or all of the prior and/or future authorization attempts associated with determined other card numbers/user accounts. The method may proceed to the end.

Steps 529, 533, and 537 may be performed consecutively or at the same time. There may be no particular order in performing those steps. In some examples, only one or two of those steps may be performed. In other examples, all the three steps may be performed after the computing device determines to apply a suspicious status to a merchant.

FIG. 6 depicts an example user interface associated with detecting and preventing suspicious payment card authorization attempts in accordance with one or more example embodiments. In FIG. 6, an example fraud detection and prevention system user interface 600 may comprise merchant names 610, notifications 620, scores 630, and actions 640. The merchant names 610 may comprise a list of merchants that have a suspicious status. The notifications 620 may comprise each satisfied notification rule for a corresponding merchant. The scores 630 may comprise a score for each merchant. The actions 640 may comprise the determined actions based on the notifications for each corresponding merchant.

The action may be determined based on a score generated from the notifications. As an example, for merchant A, based on a score of 70, only the received authorization attempts on merchant A may be denied and future authorization attempts on merchant A might not be automatically denied. As another example, for merchant B, based on a score of 90, both the received authorization attempts on merchant B and future authorization attempts on merchant B may be denied. As another example, for merchant C, based on a score of 60, none of the received authorization attempts on merchant C and future authorization attempts on merchant C may be denied. Instead, a flag may be generated to indicate a suspicious status for merchant C. Different types of layouts of the merchant names 610, the notifications 620, the scores 630, and the actions 640 may also or alternatively be presented on the user interface. The user interface depicted in FIG. 6 may have different appearances from those shown in the figure herein, depending upon the implementations thereof.

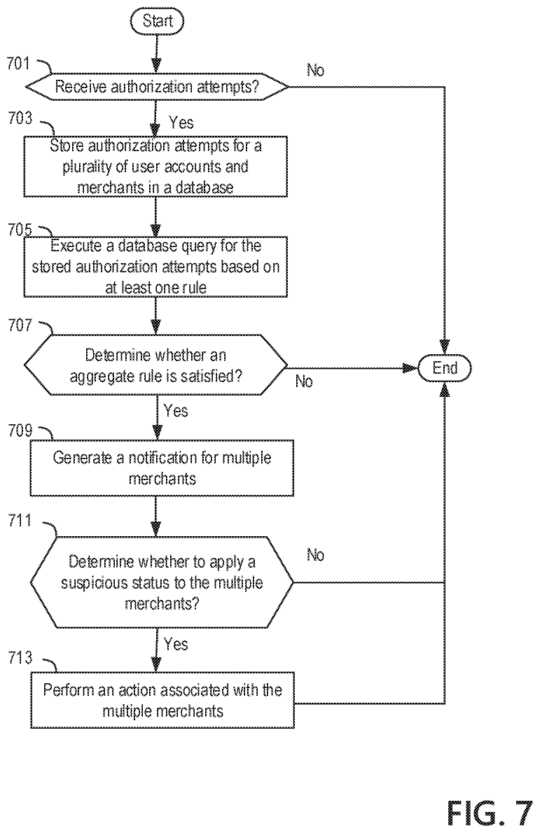

FIG. 7 depicts an illustrative method for detecting and preventing suspicious payment card authorization attempts associated with multiple merchants in accordance with one or more example embodiments. The description of FIG. 7 includes examples of computing devices that may perform various steps. However, any or all of those steps (and/or other steps) may be performed by one or more other computing devices. One or more steps may be combined, sub-divided, omitted, or otherwise modified, and/or added to other steps. The order of steps may be modified. The method described in connection with FIG. 7 may be used to determine multiple compromised merchants based on the received authorization attempts.

At step 701, a computing device (e.g., the card issuer 140, the fraud detection and prevention computing platform 310) having at least one processor, a communication interface, and memory may receive a plurality of authorization attempts. For example, the computing device may receive a plurality of authorization attempts from one or more transaction authorization networks (e.g., the transaction authorization networks 130A-130N). The received authorization attempts may be associated with multiple merchants (e.g., a first plurality of authorization attempts are used at a first merchant and a second plurality of authorization attempts are used at a second merchant). The received authorization attempts may be associated with one or more card numbers and/or user accounts. Each authorization attempt may correspond to an attempted transaction and may be associated with a respective merchant (e.g., the merchant 120) of a plurality of merchants and a respective user account of a plurality of user accounts. The received authorization attempts may be part of an enumeration attack, aiming to determine the validity of card information. But the received authorization attempts may have not been flagged by the one or more transaction authorization network as having a suspicious status. Also or alternatively, the received authorization attempts may comprise a first plurality of authorization attempts denied by an operator of the one or more transaction authorization networks and a second plurality of authorization attempts approved by the operator of the one or more transaction authorization network. The plurality of authorization attempts may be received by more than one transaction authorization network and the more than one transaction authorization network may have different operators. In an example, none of the operators or transaction authorization networks may have identified the plurality of authorization attempts as having a suspicious status or associated at least some of the plurality of authorization attempts to a fraudulent attack on a merchant. The computing device may set a time period (e.g., time interval) for receiving the authorization attempts. The time period may be set for each merchant or each type of merchant (e.g., based on the size of the merchant, based on the annual revenue of the merchant). If the computing device does not receive any authorization attempt during a time period, the method may proceed to the end.

At step 703, the computing device may store the authorization attempts (e.g., the aggregated received authorization attempts) for a plurality of user accounts and merchants in a database (e.g., the database 312). Each of the plurality of authorization attempts may correspond to an attempted transaction and may be associated with a respective merchant of a plurality of merchants (e.g., the merchant 120) and a respective user account of a plurality of user accounts.

At step 705, the computing device may generate and execute a database query for the stored authorization attempts based on at least one notification rule. The computing device may determine a plurality of notification rules (e.g., criteria of the notification rules) and may generate one or more database queries based on the notification rules and/or based on patterns corresponding to the notification rules. The database queries may request and/or retrieve data from a database (e.g., the database 312) that comprises information of the stored authorization attempts based on at least one notification rule. Each one of the notification rules may be configured to detect a respective pattern of authorization attempts associated with an account testing attack. For example, a database query may be configured to retrieve a first plurality of authorization attempts corresponding to a first merchant and a first plurality of user accounts and retrieve a second plurality of authorization attempts corresponding to a second merchant and a second plurality of user accounts. The database query may be generated based on first criteria corresponding to a first notification rule of a plurality of notification rules.

The computing device may aggregate the received authorization attempts for multiple merchants, for example, after generating the database queries. For example, the computing device may aggregate a first plurality of received authorization attempts of the total received authorization attempts if each authorization attempt of the first plurality of received authorization attempts is associated with a first merchant, and may aggregate a second plurality of received authorization attempts of the total received authorization attempts if each authorization attempt of the second plurality of received authorization attempts is associated with a second merchant. The second merchant may be different from the first merchant. The computing device may set one or more aggregation time periods and start time points for each merchant. The computing device may start aggregating the received authorization attempts for multiple merchants based on the set time period and start time point.

At step 707, the computing device may determine whether first criteria of an aggregate notification rule is satisfied. The computing device may determine, among the satisfied notification rules, whether first criteria of an aggregate notification rule is satisfied. As described above, an aggregate notification rule may be associated with authorization attempts across multiple merchants. Because fraudulent users may perform enumeration attacks on multiple merchants and test the same cards on multiple merchants, the aggregate notification rules may identify the same user accounts and/or card information that have been used for card testing, and identify merchants that are compromised. For example, an aggregate notification rule may comprise a threshold number of authorization attempts on each of a plurality of merchants during a time interval and a threshold number of the same user accounts that have been used for the authorization attempts on the each of a plurality of merchants. If the computing device determines that first criteria of an aggregate notification rule is satisfied, the computing device may identify multiple merchants that are likely to be compromised or have been compromised. In this way, the computing device may determine other merchants that are also likely compromised or have been compromised based on the authorization attempts, even if other notification rules are not satisfied for the other merchants. If the computing device determines that none of the criteria of any notification rules is satisfied, the method may proceed to the end.

At step 709, the computing device may generate a notification for multiple merchants. If the computing device determines that an aggregate notification rule is satisfied, the computing device may generate a notification for multiple merchants. For example, if the computing device determines that a plurality of authorization attempts on a first merchant and a second merchant satisfies the first criteria of a first notification rule, the computing device may generate a notification based on determining that the plurality of authorization attempts on the first merchant and the second merchant satisfies the first criteria of the first notification rule. The notification may comprise information indicating the first merchant, the second merchant, and/or the first notification rule. The notification may indicate a suspicious status for the first merchant and the second merchant. The computing device may output the notification for the first merchant and the second merchant via a user device.

At step 711, the computing device may determine whether to apply a suspicious status to the multiple merchants. For example, the computing device may determine to apply a suspicious status to a merchant if one or more notifications are generated, or if one or more criteria of notification rules (e.g., an aggregate notification rule) are satisfied. The computing device may determine to apply a suspicious status to multiple merchants if the criteria of an aggregate notification rule is satisfied. Alternatively, the computing device may determine a score for each of the multiple merchants, similar to step 511 in FIG. 5A, and determine whether to apply a suspicious status to the merchant based on the score and one or more score thresholds (e.g., a predetermined score threshold). If the computing device determines to not apply a suspicious status to the multiple merchants, the method may proceed to the end.

At step 713, the computing device may perform an action associated with the multiple merchants. For example, if the computing device determines to apply a suspicious status to the multiple merchants, the computing device may perform one or more actions. The actions may comprise, for example, denying one, some, or all of the received authorization attempts corresponding to the multiple merchants and future authorization attempts corresponding to the multiple merchants, adding the multiple merchants to a block list that comprises a list of merchants with a suspicious status, and/or generating an alert indicating the determined suspicious status of the multiple merchants. The computing device may send the alert to one or more of the following: a card issuer administrator, one or more transaction authorization networks 130A-130N that reviewed the received authorization attempts associated with the compromised merchant, other transaction authorization networks 130A-130N, the compromised merchant, and/or other business entities or administrators.

The computing device may perform additional actions associated with the multiple merchants. The actions for each of the multiple merchants may be similar to the actions described in steps 517-527 in FIG. 5B and steps 529-539 in FIG. 5C. For example, the computing device may flag card numbers and/or user accounts used at the multiple merchants. The computing device may flag other card numbers/user accounts based on card information. The computing device may flag other card numbers/user accounts associated with the multiple merchants.

Although FIGS. 3, 4, 5A-5C, and 7 are illustrated performing the analysis and blocking activity at the card issuer 140, aspects described herein may be implemented by a card issuer, a transaction authorization network, and/or a third party analyzing transaction attempts. For example, the analysis of steps 419, 421, and/or 423 of FIG. 4 may be performed by any of a card issuer, a transaction authorization network, and/or a third party analyzing transaction attempts. Similarly, the methods described above with respect to FIG. 3 may be performed by a card issuer, a transaction authorization network, and/or a third party analyzing transaction attempts. The disclosed methods of detecting enumeration attack may be particularly useful when implemented by a transaction authorization network rather than a card issuer. Implementing these methods at a transaction authorization network could even further limit the damage of an enumeration attack by identifying it earlier in a transaction approval process.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
receiving, by a computing device, a plurality of authorization attempts from one or more transaction authorization networks;
storing the plurality of authorization attempts in a database, wherein each authorization attempt corresponds to an attempted transaction and is associated with a respective merchant of a plurality of merchants and a respective user account of a plurality of user accounts;
generating a database query configured to retrieve a first plurality of authorization attempts corresponding to a first merchant and a first plurality of user accounts, wherein:
the database query is generated based on first criteria corresponding to a first notification rule of a plurality of notification rules, and
the first criteria of the first notification rule is configured to detect a pattern of authorization attempts at a given merchant and associated with a potential account testing attack;
determining whether the first plurality of authorization attempts, corresponding to the first merchant, satisfies the first criteria of the first notification rule;
generating, based on determining that the first plurality of authorization attempts satisfies the first criteria, a notification indicating a suspicious status for the first merchant;
determining, based on the suspicious status for the first merchant, that the first plurality of user accounts is likely compromised;
performing, based on the suspicious status for the first merchant, a first action associated with the first merchant;
determining, based on the suspicious status for the first merchant, at least one other user account that is also likely compromised; and
performing, based on determining the at least one other user account, a second action associated with the at least one other user account.

2. The method of claim 1, wherein determining the at least one other user account comprises:
determining, based on the at least one other user account and one of the first plurality of user accounts sharing same partial card information, the at least one other user account.

3. The method of claim 1, wherein determining the at least one other user account is based on the at least one other user account being used at the first merchant during a first time period different from a second time period in which the first plurality of authorization attempts was received.

4. The method of claim 1, wherein performing the first action associated with the first merchant comprises:
denying the first plurality of authorization attempts and future authorization attempts associated with the first merchant.

5. The method of claim 1, wherein performing the first action associated with the first merchant comprises:
adding the first merchant to a block list that comprises a list of merchants with a suspicious status.

6. The method of claim 1, wherein performing the first action associated with the first merchant comprises:
denying a first authorization attempt associated with the first merchant based on the suspicious status for the first merchant, wherein the first authorization attempt is one of the received plurality of authorization attempts or a future authorization attempt.

7. The method of claim 1, wherein performing the first action associated with the first merchant comprises:
sending an alert indicating the suspicious status of the first merchant.

8. The method of claim 1, wherein performing the second action associated with the at least one other user account comprises:
denying future authorization attempts associated with the at least one other user account.

9. The method of claim 1, further comprising:
determining, based on a second plurality of authorization attempts corresponding to a second merchant and corresponding to the at least one other user account, a suspicious status for the second merchant, wherein performing the second action comprises:
denying the second plurality of authorization attempts and future authorization attempts associated with the second merchant.

10. The method of claim 1, further comprising:
determining, based on the first plurality of user accounts and the suspicious status for the first merchant, not-yet-issued user accounts that are already compromised or likely-to-be compromised; and
generating an indication that the not-yet-issued user accounts are already compromised or likely-to-be compromised.

11. The method of claim 1, wherein the first criteria of the first notification rule comprises a threshold number of authorization attempts on a merchant during a time interval, and wherein determining whether the first plurality of authorization attempts satisfies the first criteria of the first notification rule comprises:
determining whether a total number of authorization attempts, of the first plurality of authorization attempts, satisfies the threshold number.

12. The method of claim 1, wherein the first criteria of the first notification rule comprises a threshold number of authorization declines from a merchant during a time interval, and wherein determining whether the first plurality of authorization attempts satisfies the first criteria of the first notification rule comprises:
determining whether a total number of authorization attempts that are declined, of the first plurality of authorization attempts, satisfies the threshold number.

13. The method of claim 1, wherein the first criteria of the first notification rule comprises a threshold number of authorization declines, based on a first decline reason, from a merchant during a time interval, and wherein determining whether the first plurality of authorization attempts satisfies the first criteria of the first notification rule comprises:
determining whether a total number of authorization attempts that are declined based on the first decline reason, of the first plurality of authorization attempts, satisfies the threshold number.

14. The method of claim 1, wherein the first criteria of the first notification rule comprises a threshold number of authorization attempts for a same amount on a merchant, and wherein determining whether the first plurality of authorization attempts satisfies the first criteria of the first notification rule comprises:
determining whether a total number of authorization attempts for a given value, of the first plurality of authorization attempts, satisfies the threshold number.

15. The method of claim 1, wherein the first criteria of the first notification rule comprises a threshold number of authorization attempts for a zero amount on a merchant, and wherein determining whether the first plurality of authorization attempts satisfies the first criteria of the first notification rule comprises:
determining whether a total number of authorization attempts for a zero value, of the first plurality of authorization attempts, satisfies the threshold number.

16. The method of claim 1, wherein the first criteria of the first notification rule comprises whether a name of a merchant comprises a web address and a threshold percentage of authorization declines from a merchant during a time interval, and wherein determining whether the first plurality of authorization attempts satisfies the first criteria of the first notification rule comprises:
determining whether a name of the first merchant comprises a web address and whether a percentage of authorization attempts that are declined, of the first plurality of authorization attempts, satisfies the threshold percentage.

17. The method of claim 1, wherein the first criteria of the first notification rule comprises whether a merchant is associated with prior authorization attempts stored in the database and a threshold number of authorization attempts on a merchant during a time interval, and wherein determining whether the first plurality of authorization attempts satisfies the first criteria of the first notification rule comprises:
determining whether the first merchant is associated with prior authorization attempts stored in the database and whether a total number of authorization attempts, of the first plurality of authorization attempts, satisfies the threshold number.

18. The method of claim 1, wherein generating the notification comprises:
determining, based on determining that the first plurality of authorization attempts satisfies the first criteria of the first notification rule and based on determining that the first plurality of authorization attempts satisfies second criteria of a second notification rule, the suspicious status for the first merchant.

19. The method of claim 18, wherein the first notification rule is associated with a first weighting value and the second notification rule is associated with a respective second weighting value, wherein generating the notification comprises:
determining an aggregate score for the first merchant by applying the first weighting value to the first notification rule and the respective second weighting value to the second notification rule.

20. The method of claim 1, wherein generating the notification is further based on output of a machine learning model trained to correlate the plurality of notification rules with a suspicious status of a merchant.

21. The method of claim 1, wherein generating the notification is further based on characteristics of the first plurality of authorization attempts, and wherein the characteristics comprise at least one of the following:
a total number of the first plurality of authorization attempts,
one or more decline reasons for at least one of the first plurality of authorization attempts,
a total number of the first plurality of authorization attempts for a same amount,
a total number of the first plurality of authorization attempts for zero amount,
an indication whether a name of the first merchant comprises a web address, or
an indication whether the first merchant is associated with prior authorization attempts stored in the database.

22. The method of claim 1, wherein the plurality of authorization attempts comprises a first set of plurality of authorization attempts denied by an operator of the transaction authorization network and a second set of plurality of authorization attempts approved by the operator of the transaction authorization network.

23. The method of claim 1, wherein the plurality of authorization attempts has not been flagged by an operator of the transaction authorization network as having a suspicious status.

24. The method of claim 1, wherein receiving the plurality of authorization attempts comprises receiving the plurality authorization attempts from more than one transaction authorization networks, and wherein the more than one transaction authorization networks have different operators.

25. A method comprising:
receiving, by a computing device, a plurality of authorization attempts from one or more transaction authorization networks;
storing the plurality of authorization attempts in a database, wherein each authorization attempt corresponds to an attempted transaction and is associated with a respective merchant of a plurality of merchants and a respective user account of a plurality of user accounts;
generating one or more database queries configured to retrieve a first plurality of authorization attempts corresponding to a first merchant and a first plurality of user accounts and a second plurality of authorization attempts corresponding to a second merchant and a second plurality of user accounts, wherein:
the one or more database queries is generated based on first criteria corresponding to a first notification rule, and
the first criteria of the first notification rule is configured to detect a respective pattern of authorization attempts at multiple merchants and associated with a potential account testing;
generating, based on determining that the first plurality of authorization attempts and the second plurality of authorization attempts satisfy the first criteria of the first notification rule, a notification indicating a suspicious status for the first merchant and the second merchant; and
determining, based on the suspicious status for the first merchant and the second merchant, that the first plurality of user accounts and second plurality of user accounts are likely compromised;
performing, based on the suspicious status for the first merchant and the second merchant, an action associated with the first merchant and the second merchant.

26. The method of claim 25, wherein performing the action comprises:
denying the first plurality of authorization attempts and future authorization attempts associated with the first merchant; and
denying the second plurality of authorization attempts and future authorization attempts associated with the second merchant.

27. The method of claim 25, further comprising:
determining, based on the suspicious status for the first merchant and the second merchant, at least one other user account as being likely compromised; and
performing, based on determining the at least one other user account as being likely compromised, a second action associated with the at least one other user account.

28. The method of claim 25, wherein the first criteria of the first notification rule comprises a threshold number of authorization attempts on a merchant during a time interval, and wherein generating the notification comprises:
determining whether a total number of authorization attempts, of the first plurality of authorization attempts, satisfies the threshold number and whether a total number of authorization attempts, of the second plurality of authorization attempts, satisfies the threshold number.

29. A computing device, comprising:
one or more processors; and
memory storing instructions that, when executed by the one or more processors, cause the computing device to:
receive a plurality of authorization attempts from one or more transaction authorization networks;
store the plurality of authorization attempts in a database, wherein each authorization attempt corresponds to an attempted transaction and is associated with a respective merchant of a plurality of merchants and a respective user account of a plurality of user accounts;
generate a database query configured to retrieve a first plurality of authorization attempts corresponding to a first merchant and a first plurality of user accounts, wherein:
the database query is generated based on first criteria corresponding to a first notification rule of a plurality of notification rules, and
the first criteria of the first notification rule is configured to detect a pattern of authorization attempts at a given merchant and associated with a potential account testing attack;
determine whether the first plurality of authorization attempts, corresponding to the first merchant, satisfies the first criteria of the first notification rule;
generate, based on determining that the first plurality of authorization attempts satisfies the first criteria, a notification indicating a suspicious status for the first merchant;
determine, based on the suspicious status for the first merchant, that the first plurality of user accounts is likely compromised;
perform, based on the suspicious status for the first merchant, a first action associated with the first merchant;
determine, based on the suspicious status for the first merchant, at least one other user account that is also likely compromised based on the first plurality of user accounts or the first merchant; and
perform, based on determining the at least one other user account, a second action associated with the at least one other user account.

30. One or more non-transitory computer-readable media storing instructions that, when executed by one or more processors, cause a computing device to perform steps comprising:
receiving a plurality of authorization attempts from one or more transaction authorization networks, wherein the plurality of authorization attempts has not been flagged by an operator of the one or more transaction authorization networks as having a suspicious status;
storing the plurality of authorization attempts in a database, wherein each authorization attempt corresponds to an attempted transaction and is associated with a respective merchant of a plurality of merchants and a respective user account of a plurality of user accounts;
generating a database query configured to retrieve a first plurality of authorization attempts corresponding to a first merchant and a first plurality of user accounts, wherein:
the database query is generated based on first criteria corresponding to a first notification rule of a plurality of notification rules, and
the first criteria of the first notification rule is configured to detect a pattern of authorization attempts at a given merchant and associated with a potential account testing attack;
determining whether the first plurality of authorization attempts, corresponding to the first merchant, satisfies the first criteria of the first notification rule;
generating, based on determining that the first plurality of authorization attempts satisfies the first criteria, a notification indicating a suspicious status for the first merchant;
determining, based on the suspicious status for the first merchant, that the first plurality of user accounts is likely compromised;
performing, based on the suspicious status for the first merchant, a first action associated with the first merchant;
determining, based on the suspicious status for the first merchant, at least one other user account that is also likely compromised; and
performing, based on determining the at least one other user account, a second action associated with the at least one other user account.
